(19) United States
(12) Patent Application Publication
(10) Pub. No.: US 2013/0340969 A1
(43) Pub. Date: Dec. 26, 2013

(54) ENERGY EXCHANGE BUILDING ENVELOPE

(71) Applicants: Jason Vollen, Brooklyn, NY (US); Kelly Winn, Troy, NY (US); Anna Dyson, New York, NY (US); Ted Ngai, Teaneck, NJ (US)

(72) Inventors: Jason Vollen, Brooklyn, NY (US); Kelly Winn, Troy, NY (US); Anna Dyson, New York, NY (US); Ted Ngai, Teaneck, NJ (US)

(73) Assignee: Rensselae Polytechnic Institute

(21) Appl. No.: 14/000,899

(22) PCT Filed: Feb. 24, 2012
(86) PCT No.: PCT/US12/26576

§ 371 Date: Aug. 22, 2013

Related U.S. Application Data
(60) Provisional application No. 61/463,910, filed on Feb. 24, 2011.

(51) Int. Cl. E04F 13/07; C09K 5/06

(52) U.S. Cl. CPC E04F 13/07; C09K 5/063
USPC 165/47; 252/71; 252/500; 52/573.1; 52/173.1; 420/591; 62/3.6

(57) ABSTRACT

Provided in one embodiment is an article, the article comprising: a material, which adjusts at least one surface property in response to a climate condition to affect energy exchange between the exterior and the interior of the article. Another embodiment provides a structure, comprising: a building facade envelope, comprising a material: wherein the envelope adjusts at least one surface property in response to a climate condition, to affect energy exchange between the exterior and the interior of the envelope.

### RELATED PATENT APPLICATIONS

This application claims priority to U.S. provisional application Ser. No. 61/463,910, filed on Feb. 24, 2011, entitled “HIGH PERFORMANCE BUILDING ENVELOPMENT,” which is hereby incorporated by reference in its entirety.

All publications, patents, and patent applications cited in this Specification are hereby incorporated by reference in their entirety.

### BACKGROUND

At the turn of the 20th century the height of building technology was hand-crafted ceramic tiles mounted on structural steel framing. There were more than a dozen companies nationwide employing thousands of workers making each tile from custom-built molds interpreted from architects' drawings. Few of these original companies remain and most are primarily involved in the preservation of historic buildings. The art of building with ceramics has fallen by the wayside. Yet the natural process of erosion of the Earth's surface produces clay five times faster than we could ever expect to use it. While terracotta has many desirable properties as a building material—vitrified glazed finishes (durability), thermal mass characteristics (energy efficiency), humidity controlling properties (environmental comfort), plasticity of form (structural stability)—modern building techniques prefer a resilient construction system based on sustainability and ecological principles with a streamlined design and manufacturing process.

Also, in a conventional building structure, the materials described above of the building façade envelope serve as a barrier, separating the environment of the interior from the climate exterior of the building structure. However, such a passive sheltering and insulating design is often inefficient, particularly when the climate varies significantly during a day. Also, this type of design is not versatile and needs to be changed depending on the locale of the building structure.

Thus, a need exists to develop a better design for a building façade envelope for building structure that is versatile and efficient.

### SUMMARY

One embodiment provides an article, comprising: a material, which is adjustable to a climate condition with respect to at least one surface property, to affect energy exchange between the exterior and the interior of the article.

Another embodiment provides a structure, comprising: a building façade envelope, comprising a material: wherein the envelope adjusts at least one surface property in response to a climate condition, to affect energy exchange between the exterior and the interior of the envelope.

Another embodiment provides a structure, comprising: a building façade envelope, comprising a plurality of a plurality of ceramic tiles and a storage container; wherein the envelope adjusts at least one surface property in response to a climate condition to affect energy exchange between the exterior and the interior of the envelope.

Another embodiment provides a method of regulating a temperature inside a structure, the method comprising: adjusting at least one surface property of the structure to a climate condition to affect energy exchange between the exterior and the interior of the envelope; wherein the structure comprises a building façade envelope.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

FIG. 1 provides an illustration of a façade envelope in one embodiment.

FIG. 2 illustrates the effect of changing the coloration on the heat exchange of the material in one embodiment.

FIG. 3 illustrates the effect of changing the geometry on the heat exchange of the material in one embodiment.

FIGS. 4-5 illustrate the effect of changing the surface morphology on the heat exchange of the material in one embodiment.

FIG. 6 provides an illustration of energy transformation via the façade envelope in one embodiment.

FIG. 7 provides illustration of a façade envelope utilizing tiles containing phase change material in one embodiment.

FIG. 8 shows exemplary data demonstrating the superior energy savings of the façade envelope in one embodiment.

FIG. 9 provides an illustration of the contrast between conventional façade structure and the façade envelope in one embodiment.

FIGS. 10-11 provide schematic illustrations of a building façade envelope in one embodiment.

FIGS. 12-14 illustrate the parameters considered during the manufacturing of the structure in one embodiment.

FIGS. 15(A)-15(D) and 16(A)-16(D) illustrate the differences (with respect to the various design parameters) between a façade envelope construction used for respectively a hot and arid environment and a hot and humid environment.

FIGS. 17(A)-17(C) provide schematic drawings of the alternative view of a façade assembly according to one embodiment.

FIG. 18 provides an illustration of an adjustment strategy depending on the locale of the façade envelope in one embodiment.

FIG. 19 provides an illustration of an adjustment strategy depending on the locale of the façade envelope in one embodiment.

FIG. 20 provides an illustration of energy transformation via the façade envelope in one embodiment.

FIG. 21 provides an illustration of the contrast between conventional façade structure and the façade envelope in one embodiment.

FIGS. 22(A)-22(C) provide illustrations of an adjustment strategy depending on the locale of the façade envelope in one embodiment.

FIGS. 23 shows exemplary data demonstrating the superior energy savings of the façade envelope in one embodiment.

FIGS. 24 illustrates self-shading articulation in one embodiment.

### DETAILED DESCRIPTION

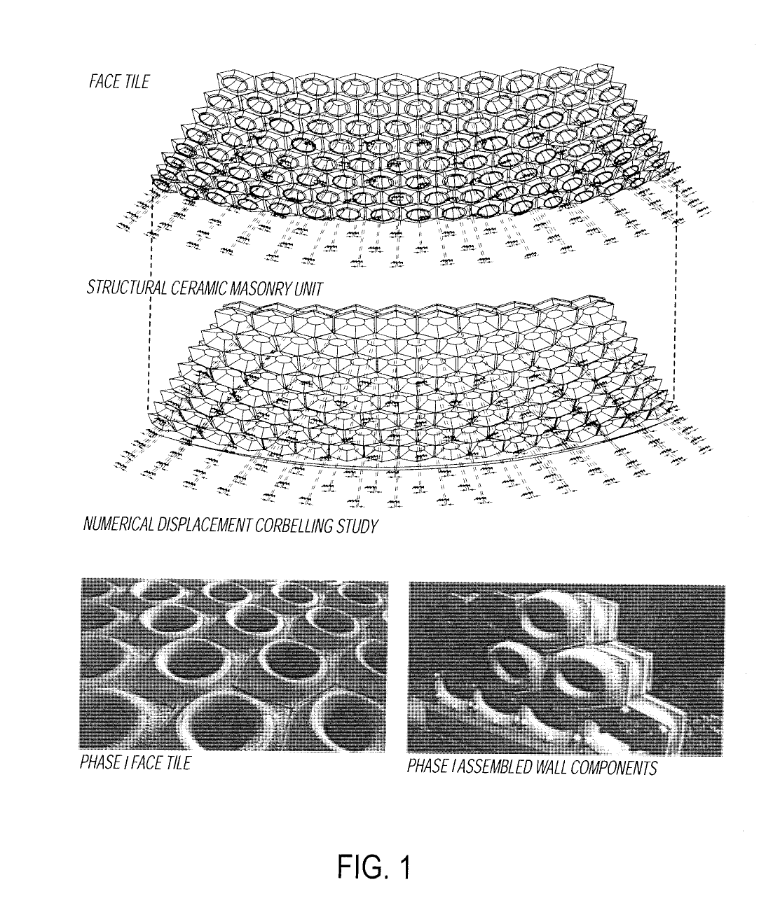

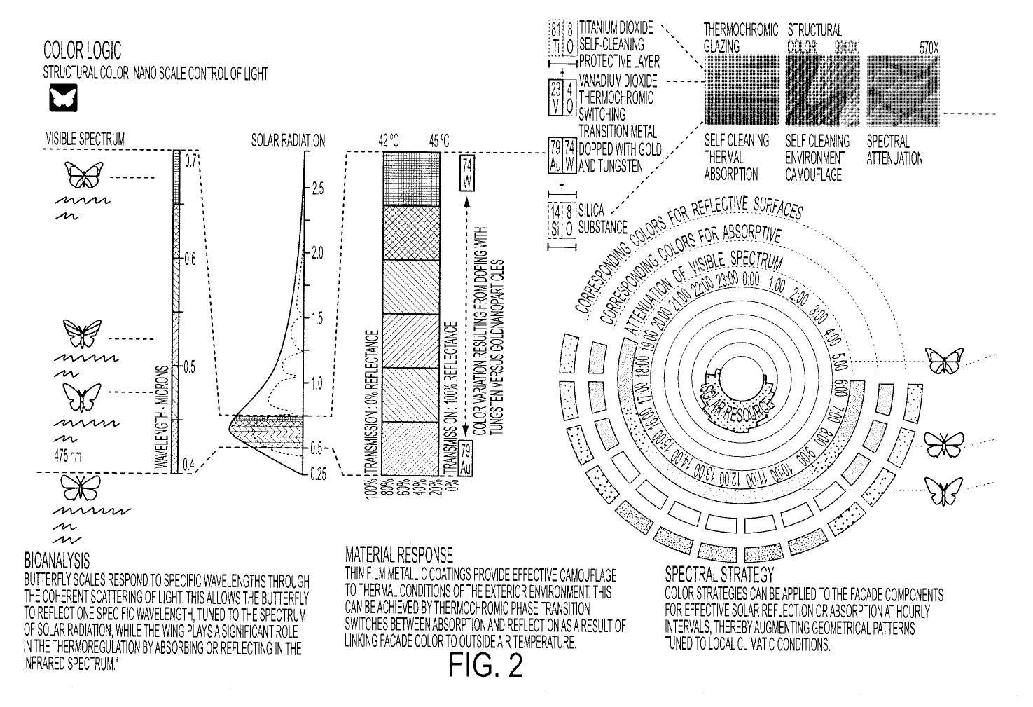

Traditional building façade s use barrier technology (insulation) to separate the interior from the exterior in buildings. This passive approach often results in a loss of an opportunity to harness the energy from the environment. The façade envelope described herein passes energy through the envelope to collect, reject, transfer, or transform that resource into useful energy to reduce the need for additional heating, cooling, and electricity, thereby to thermo-regulate the building. Thus, the façade envelope described herein may increase the efficiency of the building system matrix and reduce the energy expenditures and carbon footprint of the building and its operations over time. FIG. 1 provides an illustration of a façade envelope in one embodiment.

One aspect of the inventive embodiments described herein is related to an article, which contains a material that adjusts at least one of its surface properties to affect energy exchange between the exterior and the interior of the article. In one embodiment, the article is a part of a building façade envelope of a structure, such as a building structure. In some embodiments, the building façade envelope is referred to as a “climate camouflage envelope.”

The building façade envelopes (or “building envelope” or “façade envelope” for short described herein) may be an energy transfer and/or exchange assembly that harnesses bioclimatic energy flows via a modular design of a façade . The building envelope may be modular at least in one sense that it may adjust at least some of its properties, such as a surface property, in response to the environment, such as the climate of the environment. For example, in one embodiment, the building envelope may contain a modular ceramic (or other similar) curtain wall or masonry envelope type system to promote effective thermal balance through the use of multi-scalar color, texture, and morphology that tune the façade envelope in response to a climate or a climate change.

### Façade Materials

The façade envelope may contain any suitable materials for its application, particularly depending on the locale of the building. The material may be ceramic, metal, polymers, or composites or combinations thereof. For example, the material may be a z-dimensional material. A z-dimensional material may be any material that can be rendered in a volume, unlike sheet goods, such as plywood, which have a small z dimension in relation to the x and y dimension. For example, tiles would be a z-dimensional material out of respectively cast aluminum or pressed metal sheets, resins, etc. The ceramic may be any ceramic that is known and used in the building industries. For example, the ceramic may be clay, including any alumina silicate based ceramic (e.g., kaolin based clays, stonewares, terra cotta etc.)

Depending on the applications, the ceramic materials may be made by any suitable methods. For example, the material may be made by pressure cast (or other similar) process of large-scale precision ceramic components. In some embodiments, the ceramic material may be in the form of oversized tiles (or panel scale), which are in the same length scale as conventional solar panels. Accordingly, in some embodiments, depending on the materials used, the façade may also be used to collect solar energy.

The façade envelope may contain a material that is a metal. The metal may be any metal, depending on the application and locale of the structure. For example, the metal may be at least one of aluminum, steel, and any other formable and/or castable metal (e.g., copper bronze, zinc, etc). In some embodiments, the façade envelope may include a combination of ceramics and metal, or composites thereof. For example, the façade envelope may comprise a ceramic wall (e.g., in the form of tiles) which is supported by a metal support, or vice versa. The metal may for example be a part of clipping system that is attached to the façade envelope.

The façade envelope may contain an integrated structure that may provide additional functionalities for affecting energy exchange. The structure may be in the form of a coating and/or a thin film. In other words, in some embodiments, the wall of the façade envelope may serve as a substrate for the thin film coating. The integrated structure may be of any type, depending on the application. In one embodiment, the structure may be a structure that may promote photovoltaic or thermoelectric capture and/or transformation process. For example, the structure may include a solar cell. A photovoltaic material be a semiconductor, which may be any semiconductor commonly known (e.g., mono- or poly- crystalline silicon, amorphous silicon, cadmium telluride, etc.). A thermoelectric material may be bismuth chalcogenides or any other known thermoelectric material. The structure may be used to promote energy generation, such as electricity generation.

In some embodiments, the façade envelope may contain a wall of a plurality of tiles, such as ceramic tiles. The tiles, or the façade envelope in general, may be coated with a coating that may provide additional functionalities. For example, the coating may contain a thermochromatic material. In some embodiments, a thermochromatic material may change color in response to a change in temperature. A thermochromatic material may be a metal, oxide, or a semiconductor. For example, a metal thermochromatic material may be vanadium, gold, and the like. For examples, an oxide thermochromatic material may be a metal oxide, which may be titanium dioxide, zinc oxide, indium (III) oxide, lead (II) oxide, cuprous mercury iodide (Cu₂HgI₄), silver mercury iodide (Ag₂HgI₄), mercury (II) iodide, vanadium dioxide, chromium (III) oxide, aluminum (III) oxide, or combinations thereof. A thermochromatic material may be a complex molecule, including bis(diethylammonium) tetrachloronickelate, bis(dimethylammonium) tetrachloronickelate, bis(diethylammonium) tetrachlorocuprate, or combinations thereof. Alternatively, a thermochromatic material may be a compound, such as nickel sulfate.

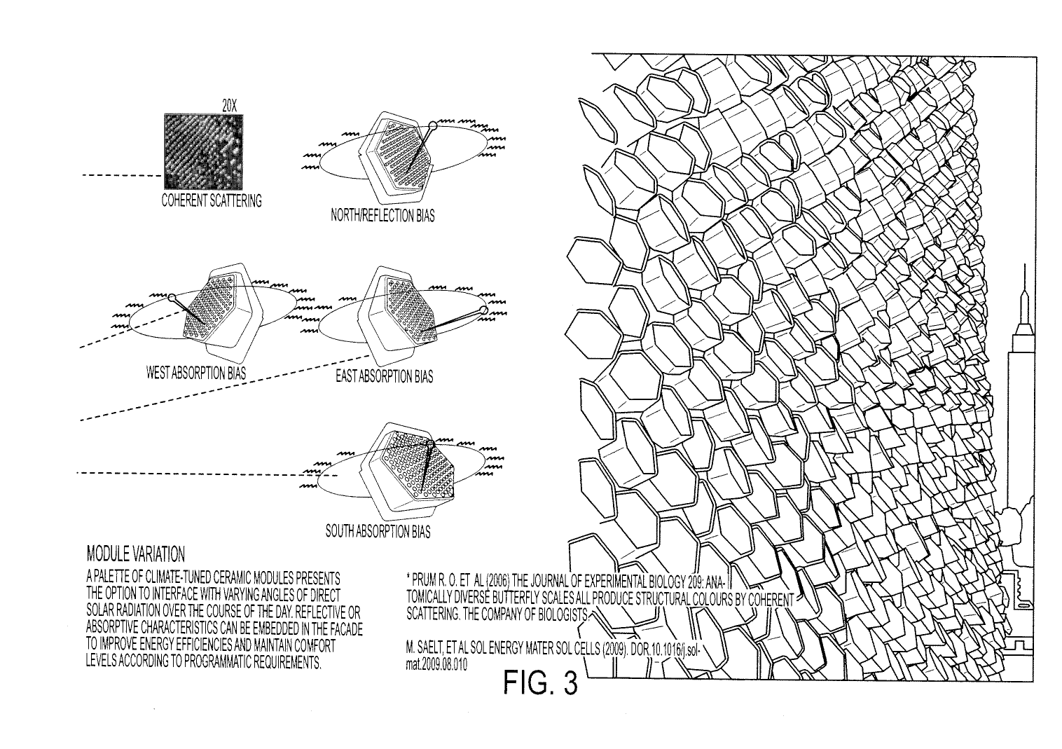

In some embodiments, due in part to the thermochromatic material, the façade envelope may change color in response to a change in the climate in the envelopment. In some embodiments, the change of color of the building façade envelope may change the absorption of the solar radiation, due to the difference in emissivity between different colors. See FIG. 2. In general, a darker material may retain more solar radiation due to its emissivity value being closer to 1; on the other hand, a lighter material may retain less solar radiation. Thus, in some embodiments, it would be desirable to have a light color of the building façade to reflect the solar energy when the sun light is the hottest and brightest to keep the interior of the building cool but to have the darker color to retain the energy in the interior when the sun light is not its hottest and brightest.

The façade envelope may further contain a phase change material (“PCM”). A PCM in some embodiments herein may refer to a substance with a high heat of fusion, which, when melting and solidifying at a certain temperature, is capable of storing and releasing large amounts of energy. Other changes of phases/states are also possible—e.g., solid-solid, solid-liquid, solid-gas, and liquid- gas phase transformation. Heat is absorbed or released when the material changes from one phase to another. In general, solid-liquid phase transition is the mostly commonly utilized transition for a PCM material.

A PCM material may be an inorganic or organic material. For example, an organic PCM material may be paraffin, fatty acids, or combinations thereof. An inorganic PCM material may be a metal hydrate, such as one with a chemical formula of MnH₂O (M represents metal). In addition, a PCM material may be a eutectic composition, such as organic-organic, organic-inorganic, inorganic-inorganic compounds.

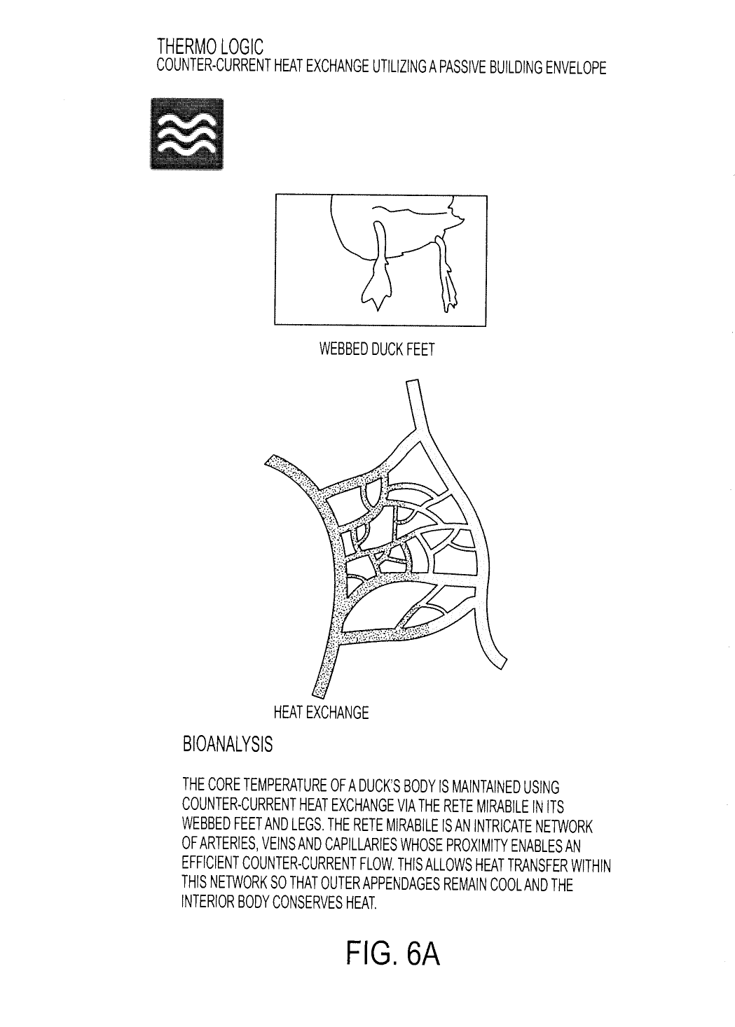

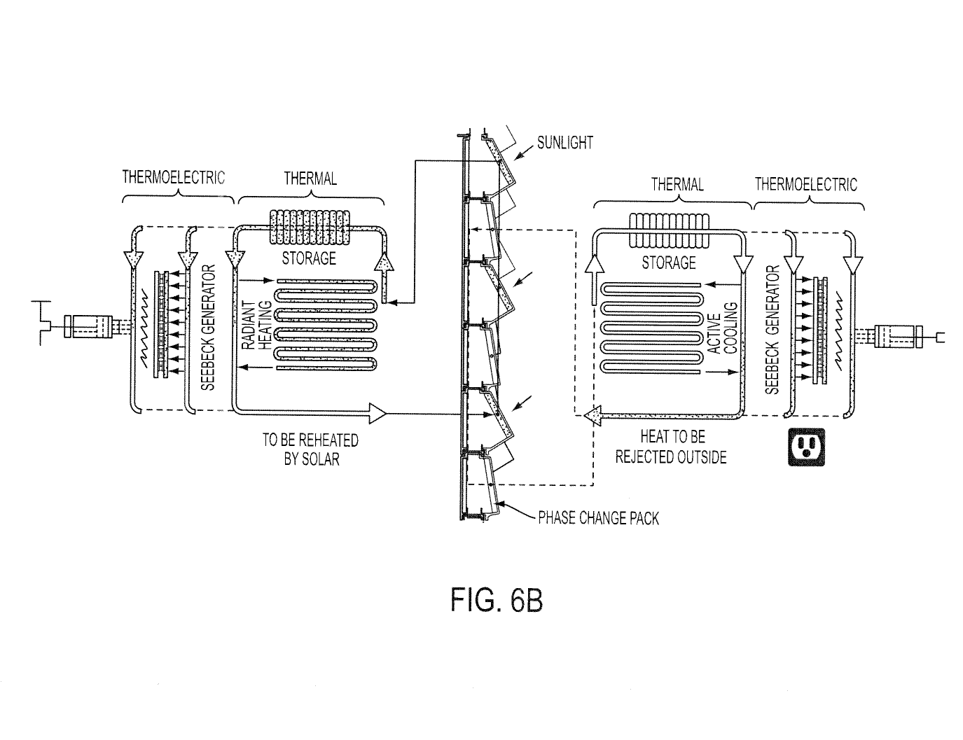

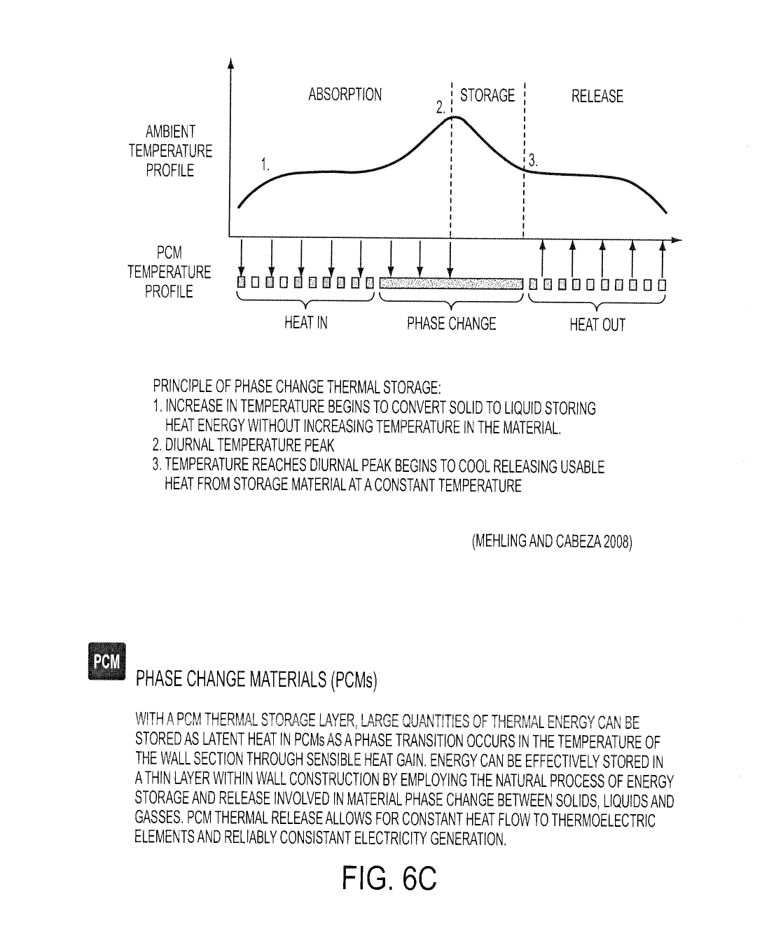

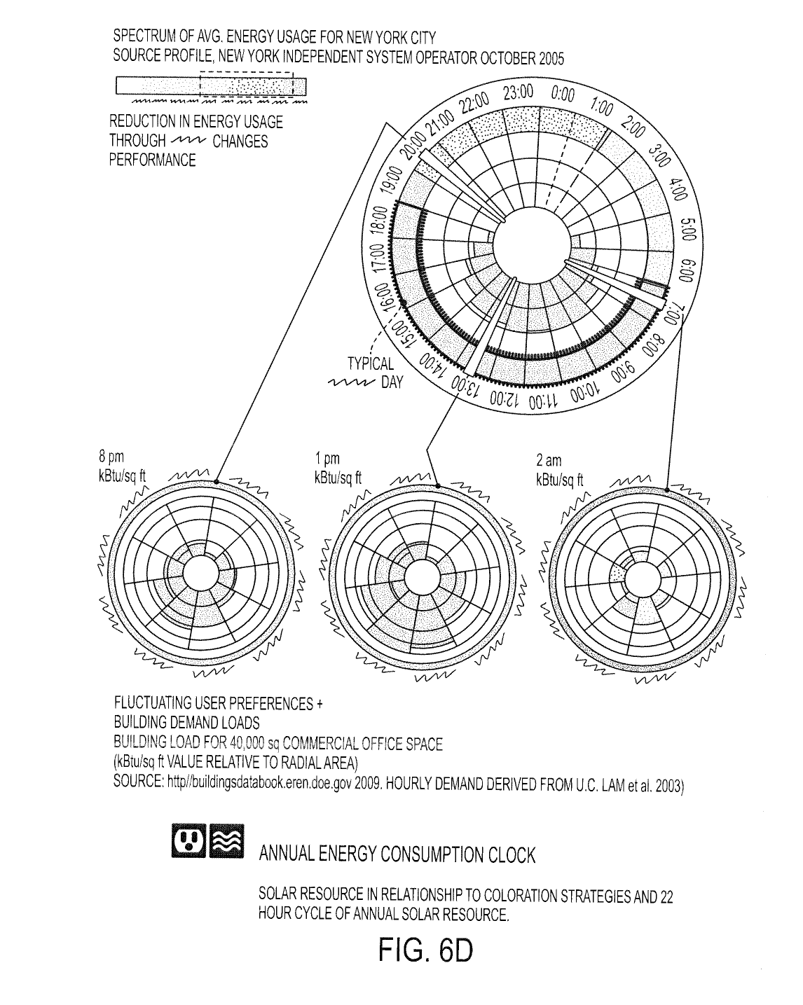

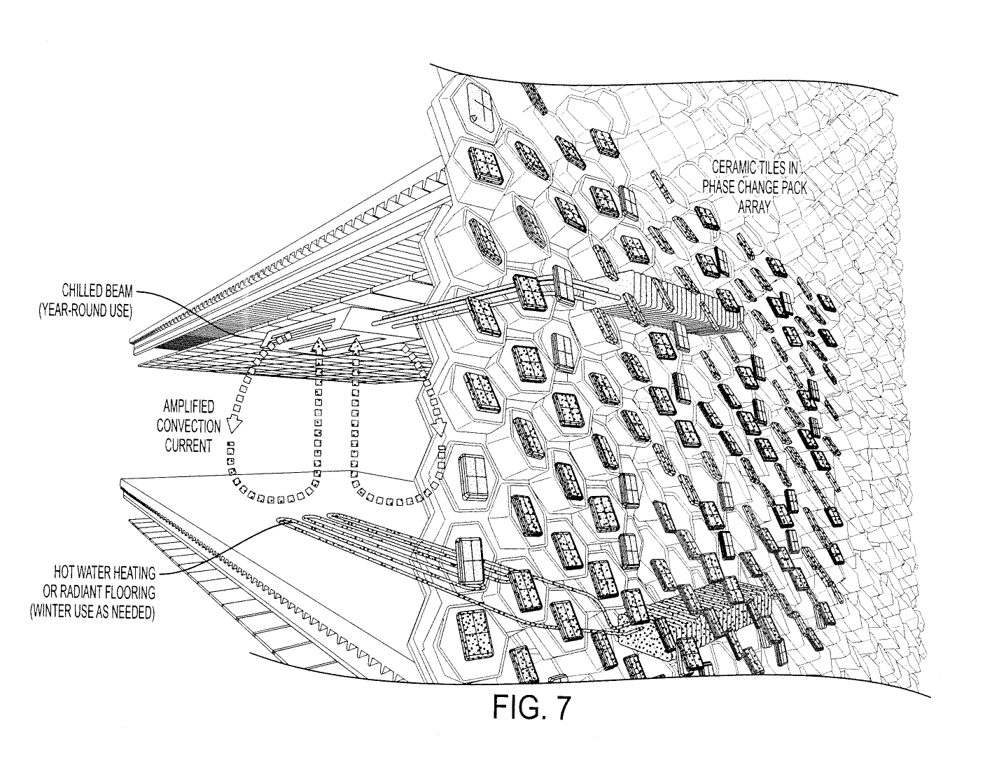

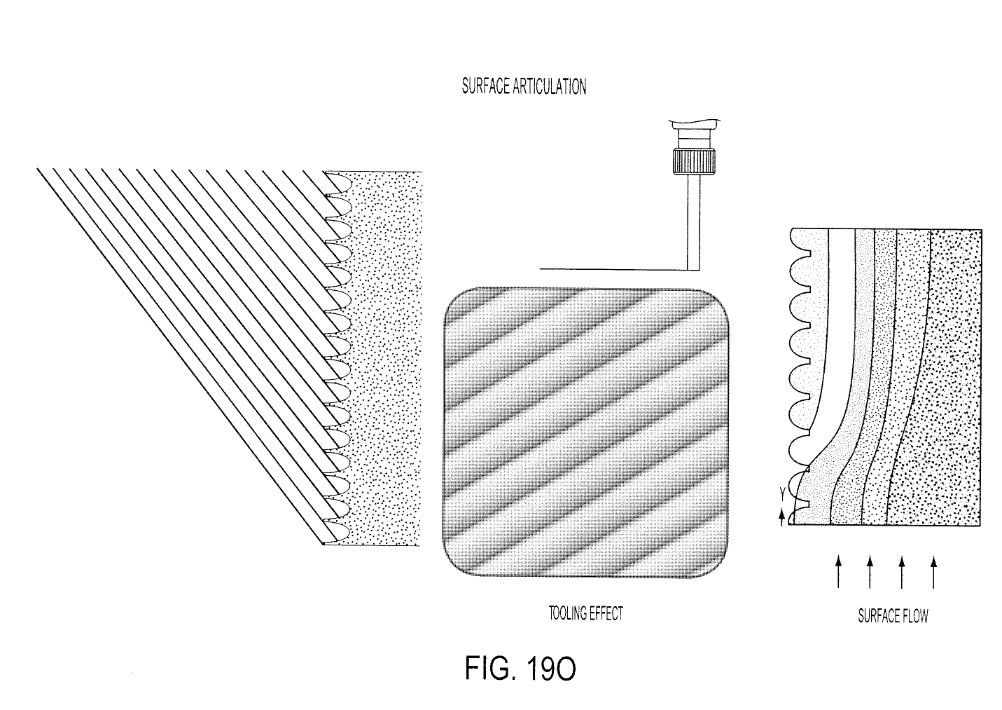

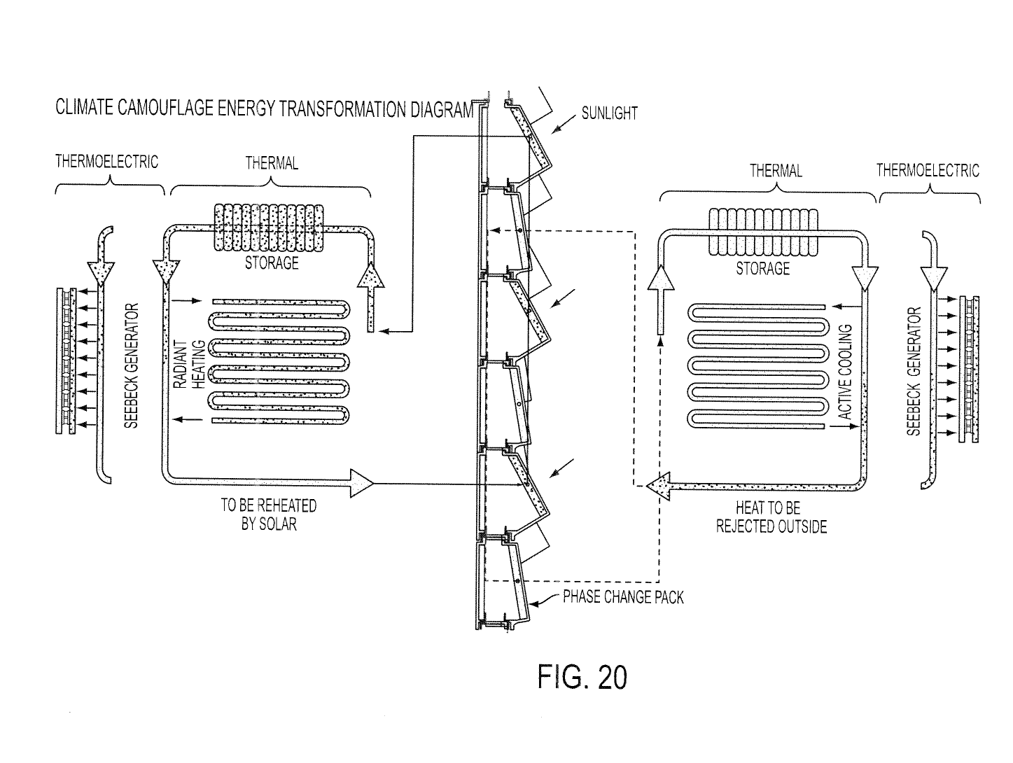

A PCM material may be integrated into the building façade envelope structure. The use of PCM into a building façade structure may be considered as bio-analytic. FIG. 6, together with FIG. 20, further illustrates this similarity. In one embodiment, the façade envelope comprises a plurality of ceramic tiles or panels, and a PCM material is integrated into the tiles and acts as a thermal sink as heat collection or cold storage for active or passive redistribution around façade envelope. See FIG. 7. The PCM material may act as, or is a part of, a storage container within the tiles, panel, or internal air cavity, combinations thereof, of the façade envelope to utilize the temperature difference between the exterior and interior of the façade envelope. In some embodiments, the PCM may be, or is a part of, a thermal battery, which produces or removes heat from supply feeds for a building system and a thermoelectric generator, or both, which may be a part of the structure or attached to the structure. The building system may refer to hot water system, mechanical system, HVAC system (e.g., cooling and/or heating system), and the like. In other words, in some embodiments, the façade envelope facilitates redistribution of energy (e.g., heat) in the building structure. As a result, the façade envelope may facilitate reduction of thermal loads on the building structure and/or even become a supplier of energy for the building structure.

The systems described herein may comprise more than one type of material. In some embodiments, by adjusting, for example, the geometry of the façade envelope, the envelope may expose different portions of the envelope to affect energy exchange. The different portions may contain materials with different material properties, such as different surface properties. For example, by altering the geometry or surface morphology of the envelope, different materials with different emissivity values may be positioned at different angles and locations to maximize energy exchange (or minimize the exchange, depending on the circumstances).

### Energy Exchange

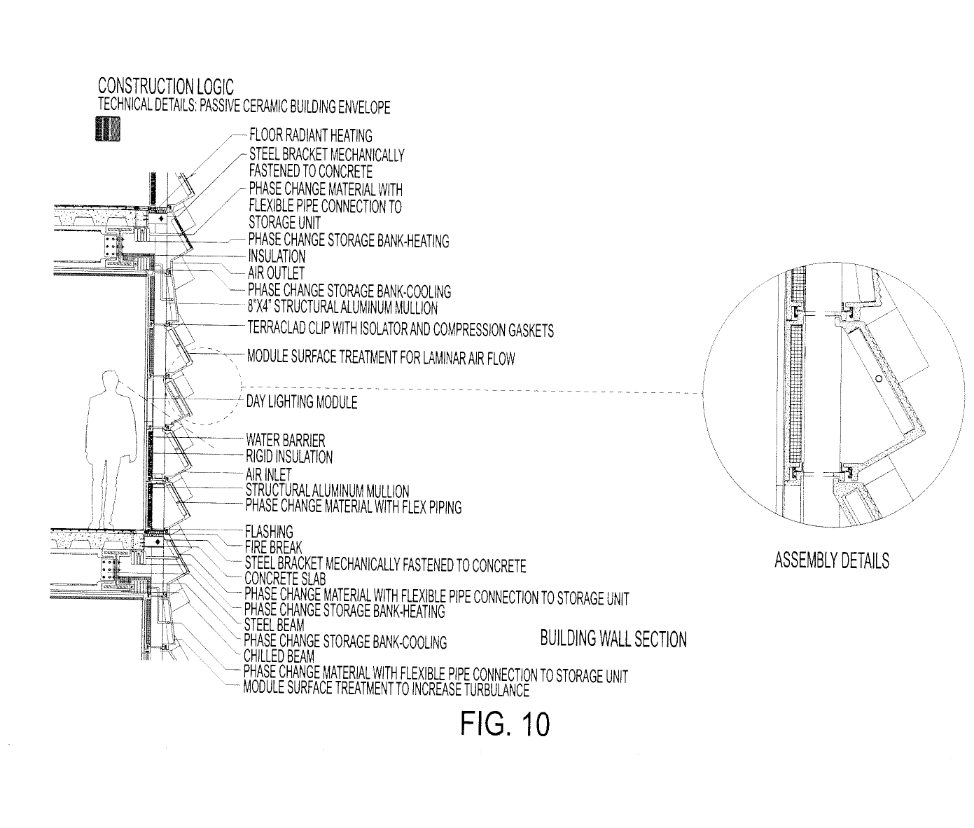

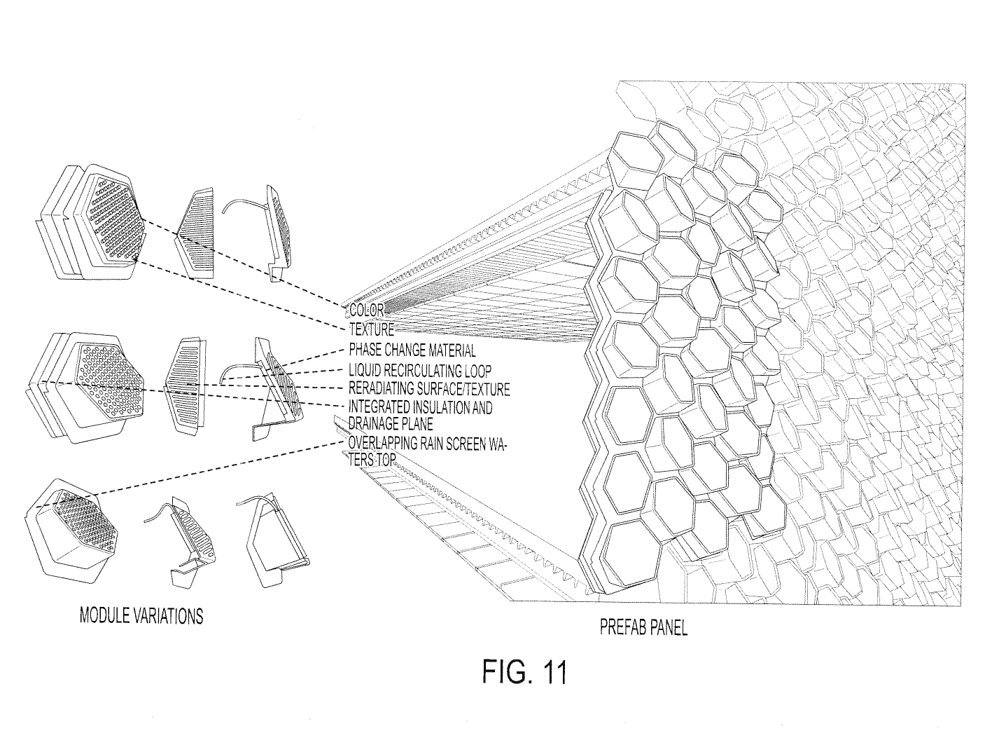

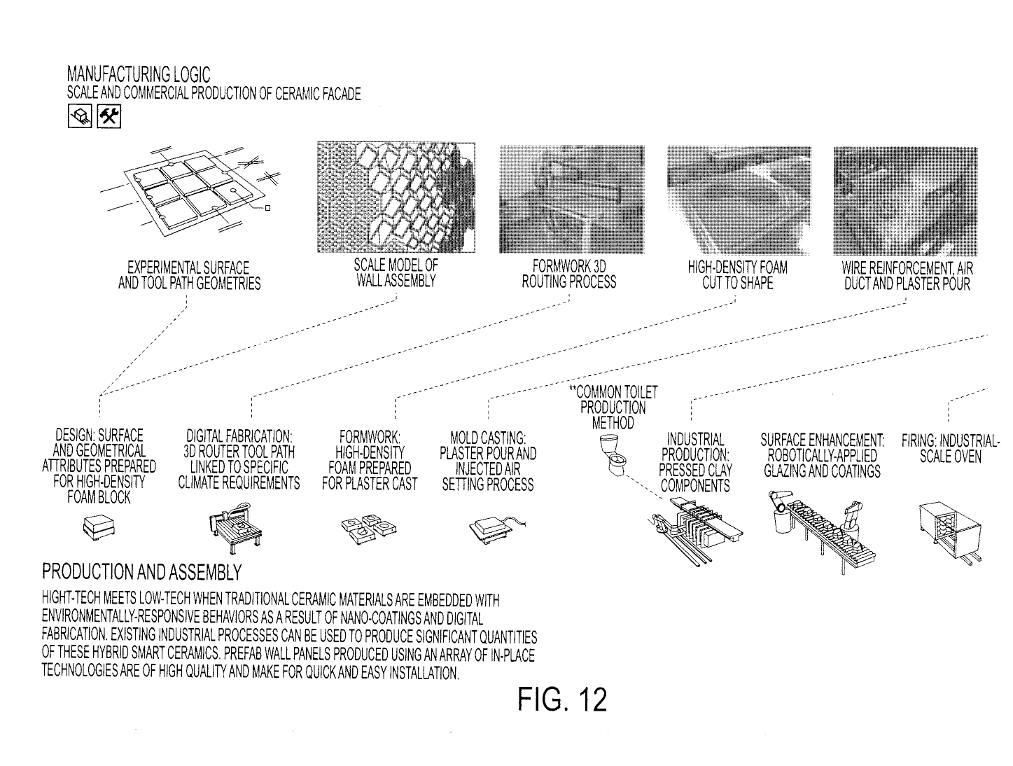

The structure and methods described herein may be utilized to affect energy transfer between the exterior and interior of a building structure. Schematic illustrations of one such construction is provided in FIG. 10 and FIG. 11. This is in stark contrast to the conventional building façade , which only acts as a passive barrier to separate the interior and the exterior of the building structure.

“Climate” herein may refer to any aspect of the environment, including temperature, level of solar radiation, level of pollutants, or combinations thereof. The climate may further refer to the change of environment during a day, such as the hottest time of the day, time of sun rise and/or sun set. In some embodiments, “climate” herein refers to the climate specific to the geographical location of the building structure.

“Energy” herein may refer to any type of energy. For example, the energy herein may refer to heat, light, solar radiation, or a combination thereof, or refer to the energy to which the building structure is exposed to. On the other hand, the energy may additionally refer to electricity when some of the exterior energy (from heat and/or solar radiation) is transformed into another form. The transformation may take place at the building façade envelope or at a device or machinery (e.g., building system as described above) attached to the building façade envelope (e.g., energy generation system such as a power generator or a battery).

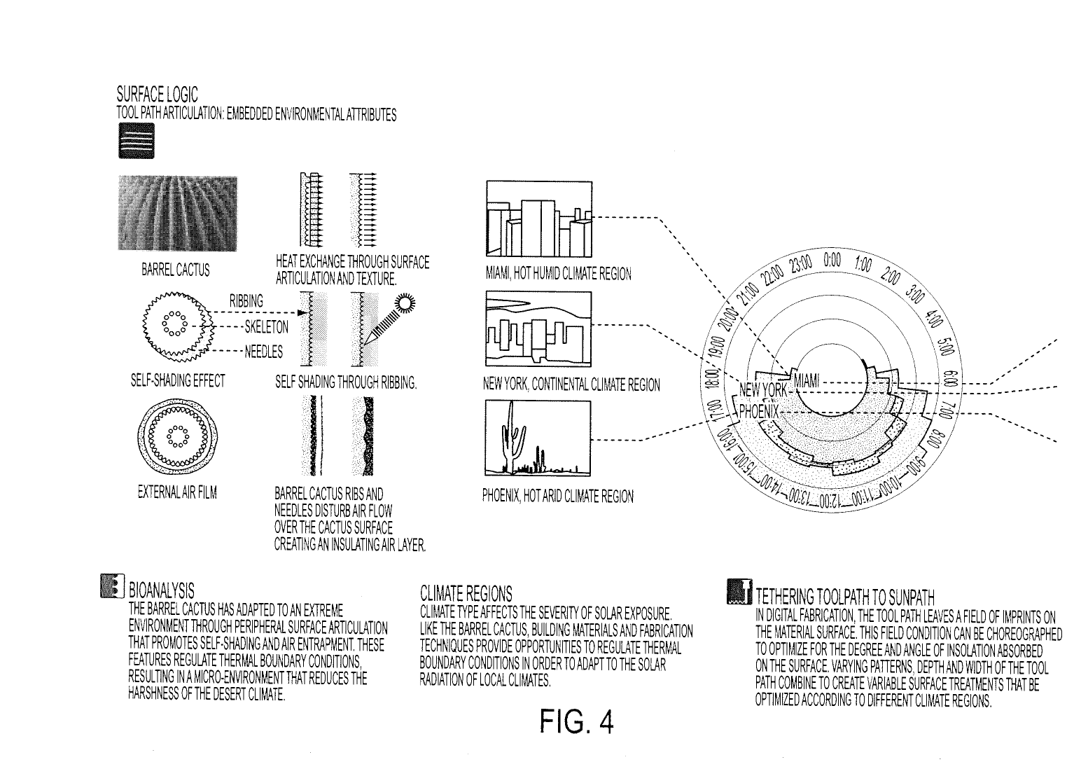

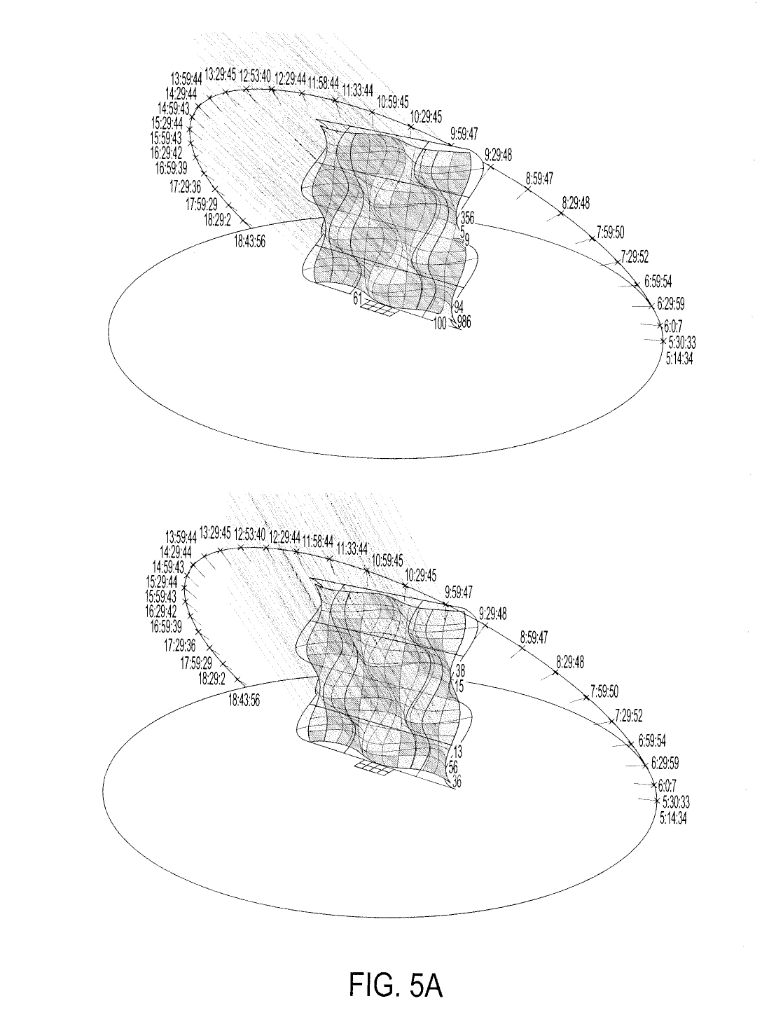

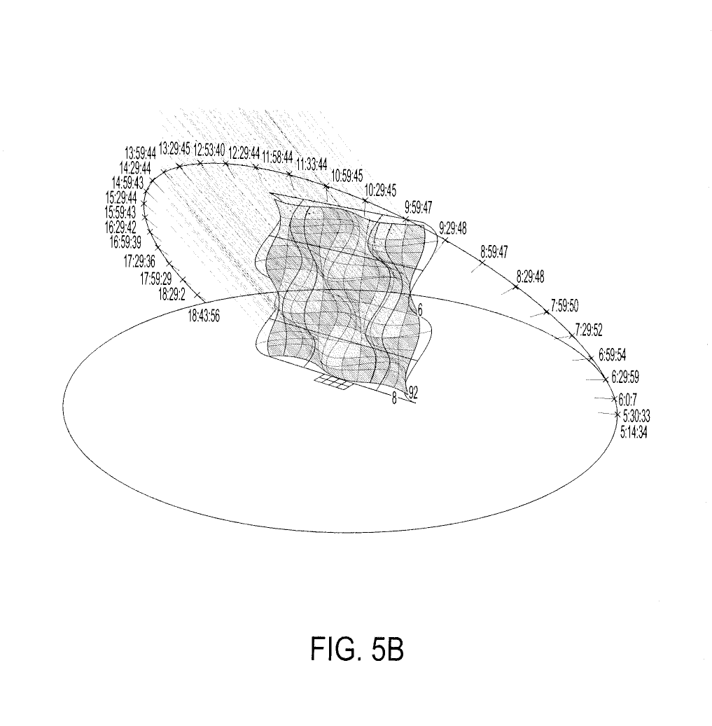

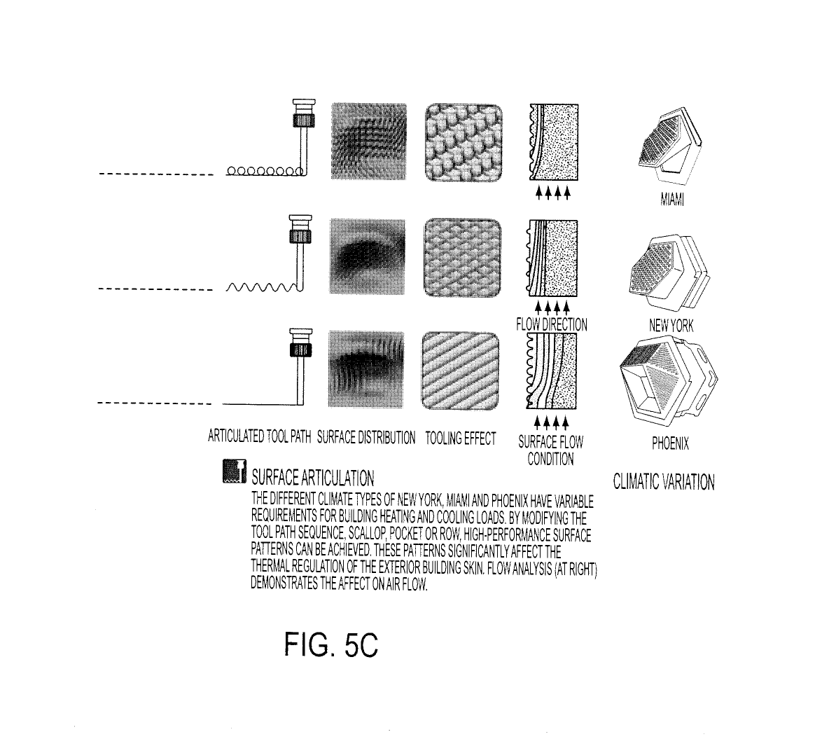

In some embodiments described herein, the building façade envelope changes at least one surface property to affect the energy exchange between the exterior and the interior of the building structure. The surface property herein may refer to any property observable at the surface of a material. For example, it can refer to the geometry, coloration, surface morphology. The effect of changing the coloration and the geometry on the thermal heat exchange of the material is illustrated in FIG. 2 and FIG. 3, respectively. Surface morphology herein may refer to surface texturing. The effect of changing surface morphology on the thermal heat exchange of the material is illustrated in FIGS. 4 and 5. The surface property may further refer to the emissivity of the material. The emissivity, as described above, may be a function of the floor, and thus a change in coloration may indirectly change the emissivity.

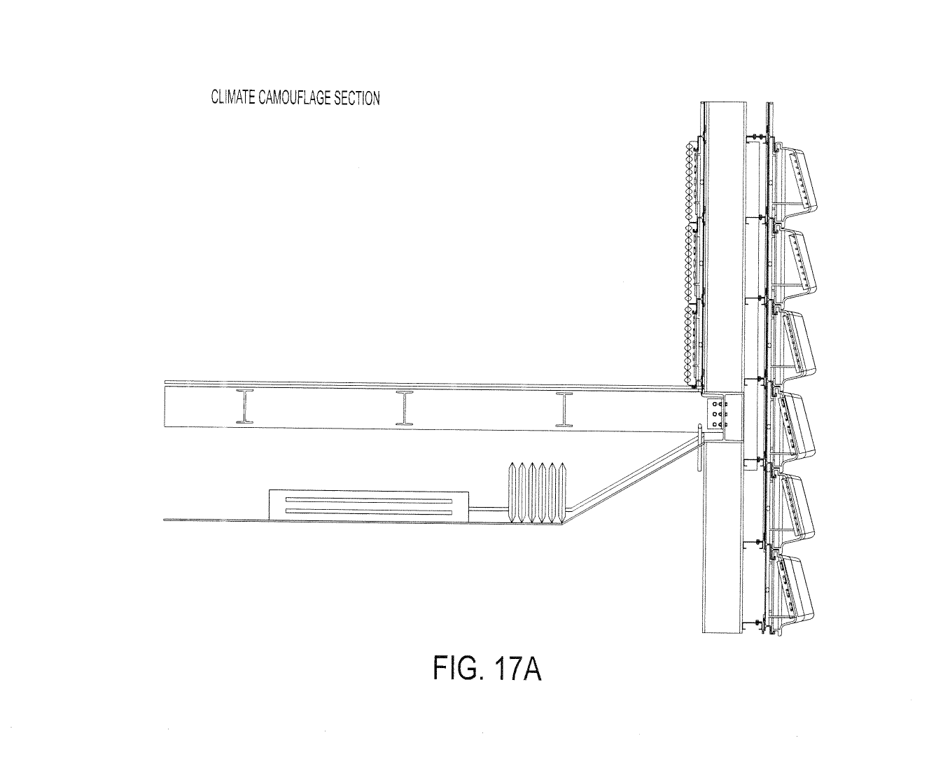

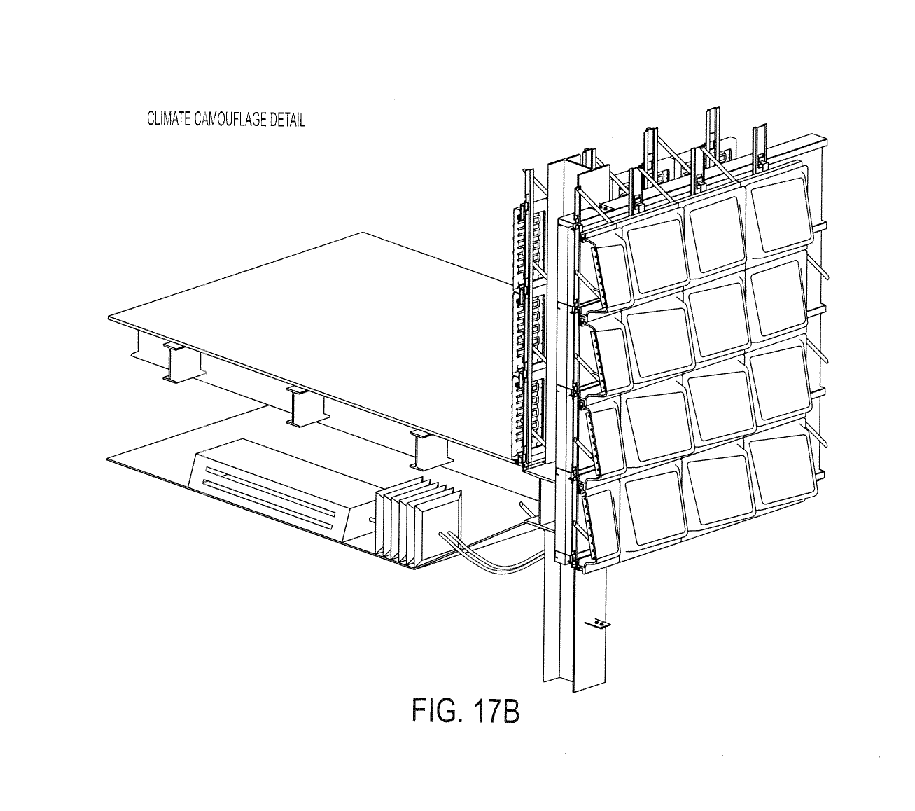

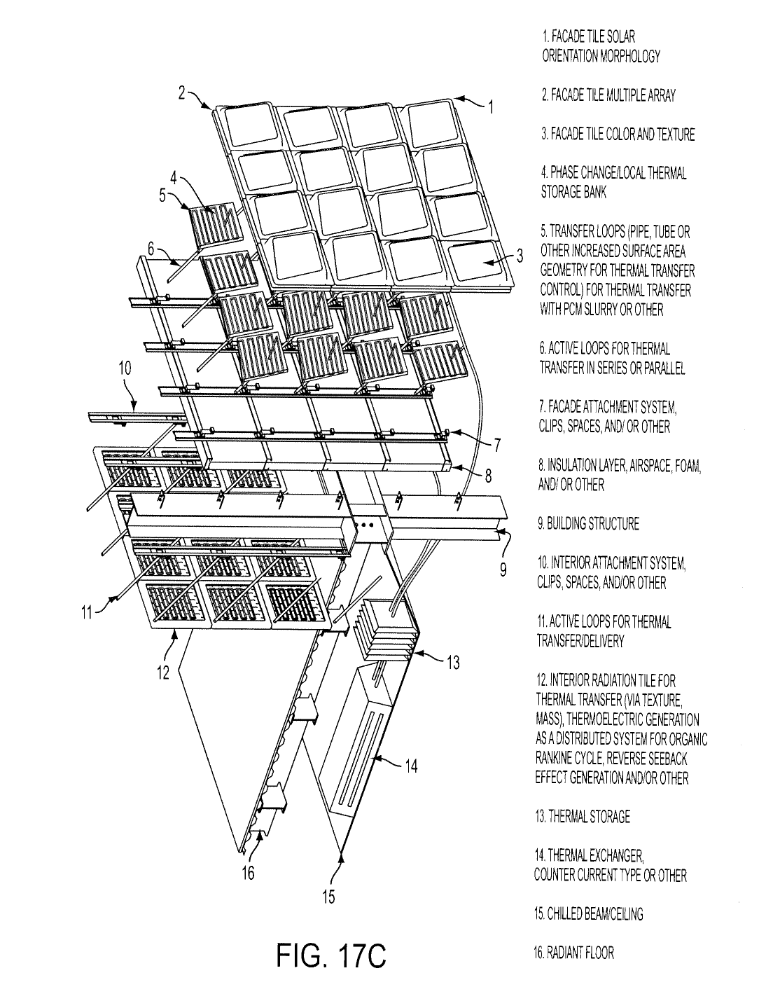

FIGS. 17(A)-17(C) provide schematic illustrations of a façade envelope assembly (herein referred to as “façade envelope” or “building façade envelope” for short) in one embodiment. FIG. 17(A) shows a cross-sectional view of such an assembly. FIGS. 17(B) and 17(C) illustrate the different components of the assembly in one embodiment. The façade envelope 1 may comprise a plurality (e.g., arrays 2) of tiles 3, as shown in FIG. 17(C). As described below, the tiles may have a designated surface property, such as color and/or texture. The façade envelope on a building structure 9 may optionally include a phase change/local thermal storage bank 4 as a component. Further, the façade envelope may further include transfer loops 5 (e.g., pipe, tube, or other increased surface area geometry for thermal transfer control) for thermal transfer with phase change material slurry or active loops 6, 11 for thermal transfer in series or in parallel. The façade envelope may additionally include attachment system 7 (e.g., clips, spaces, etc.) and/or an interior attachment system 10 (e.g., clips, spaces etc. The façade envelope may additionally include insulation layer 8 (e.g., airspace, foam, etc.) The envelope may contain interior radiation tile 12 for thermal transfer (via texture and/or mass), thermoelectric generation as a distributed system for organic Rankine Cycle, Reverse Seebeck effect generation, etc. The envelope may further contain a thermal storage 13, thermal exchanger 14 (e.g., counter current type), and/or chilled beam or ceiling 15. In some embodiments, the structure assembly may further comprise a radiant floor.

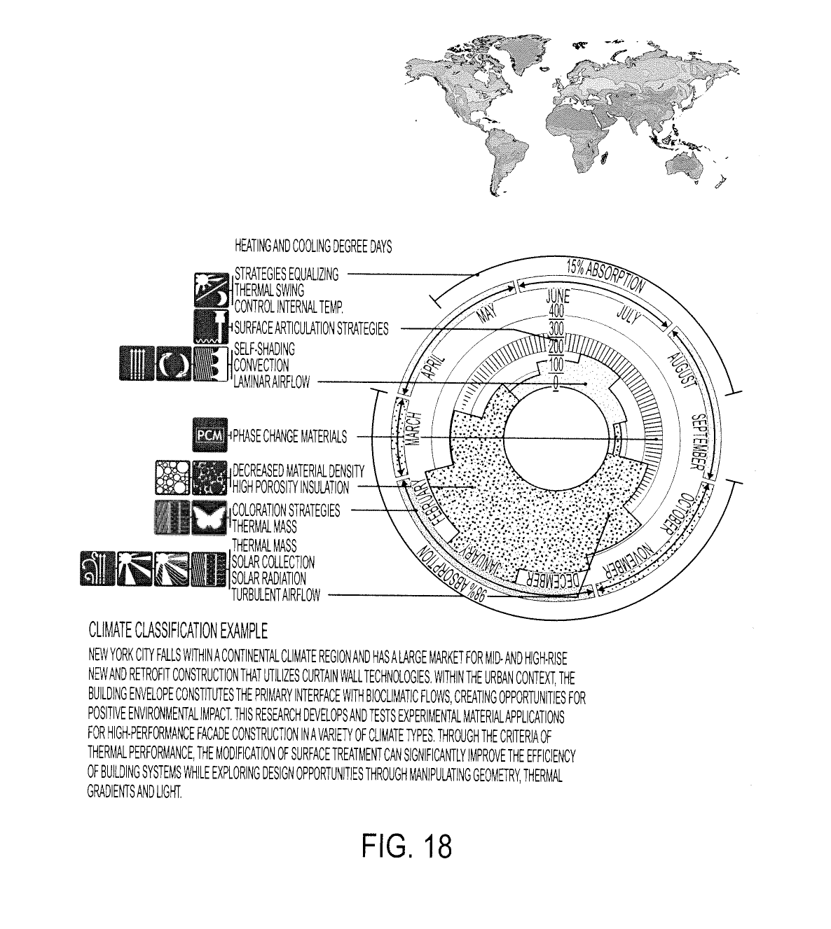

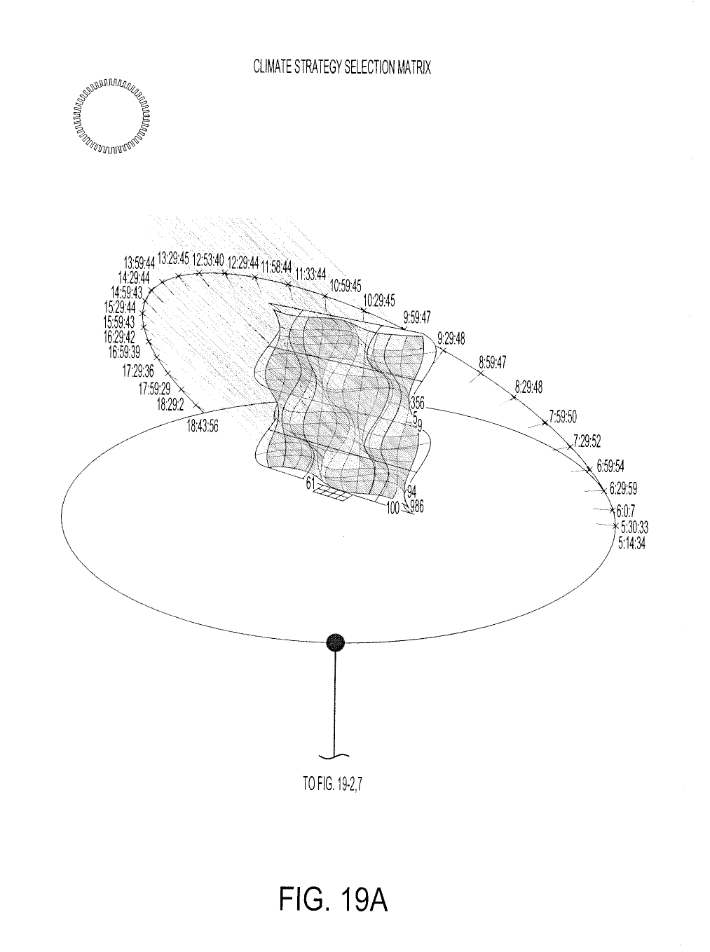

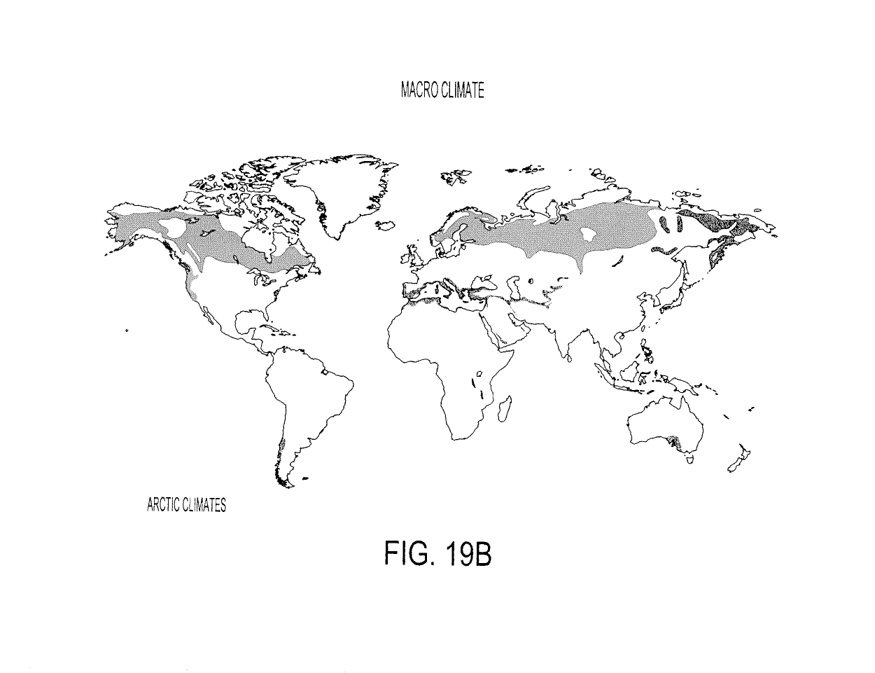

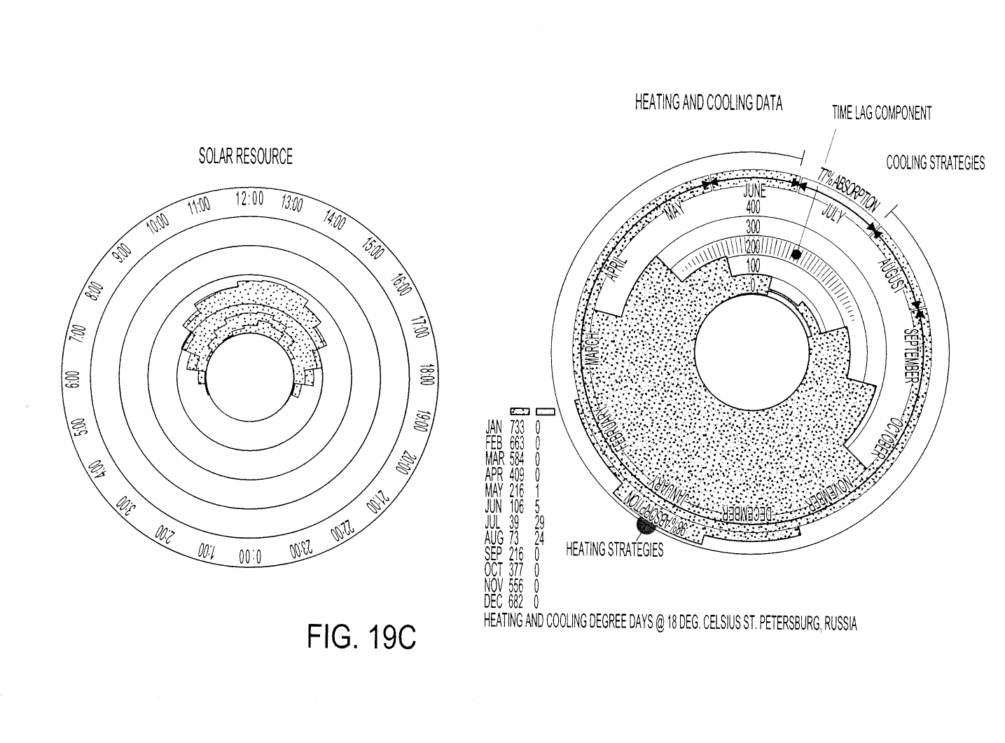

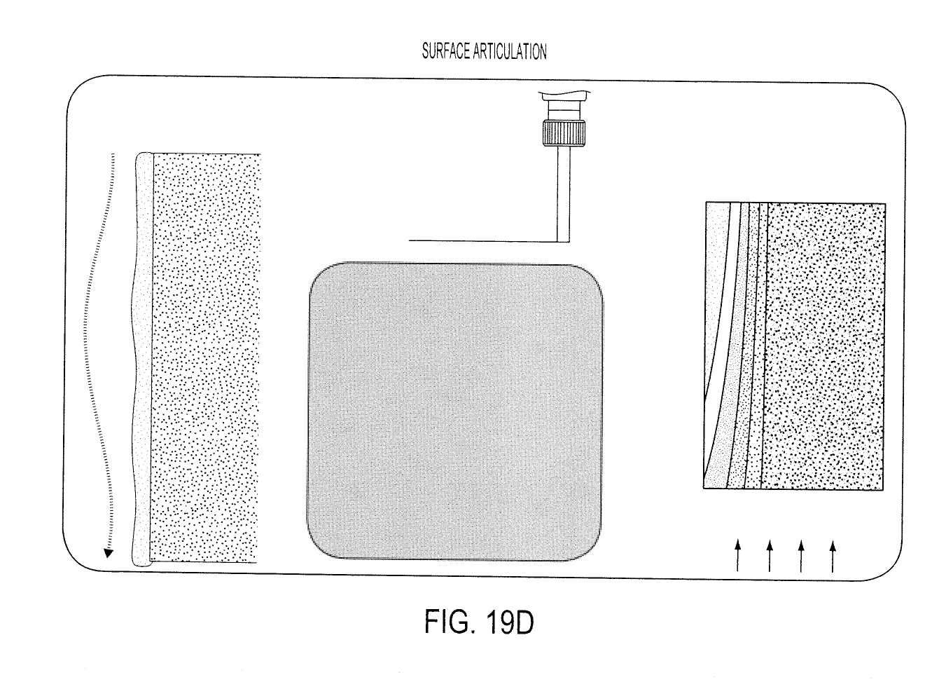

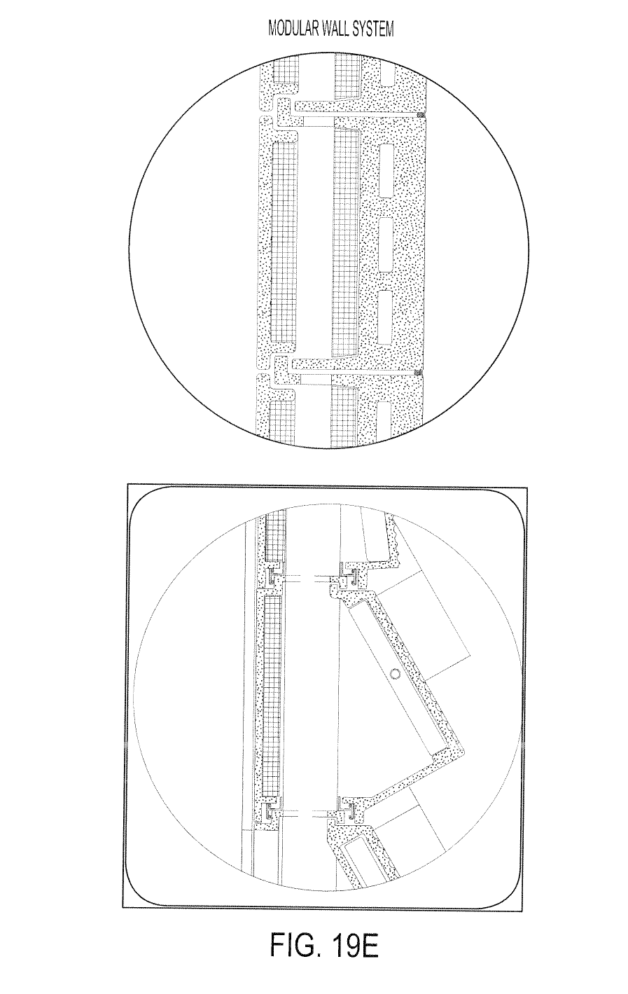

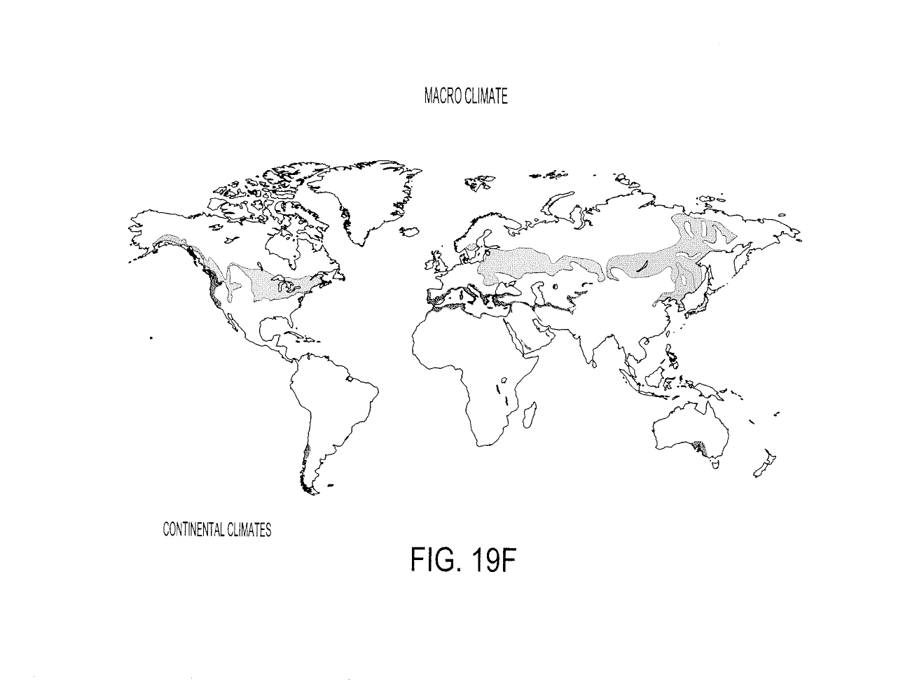

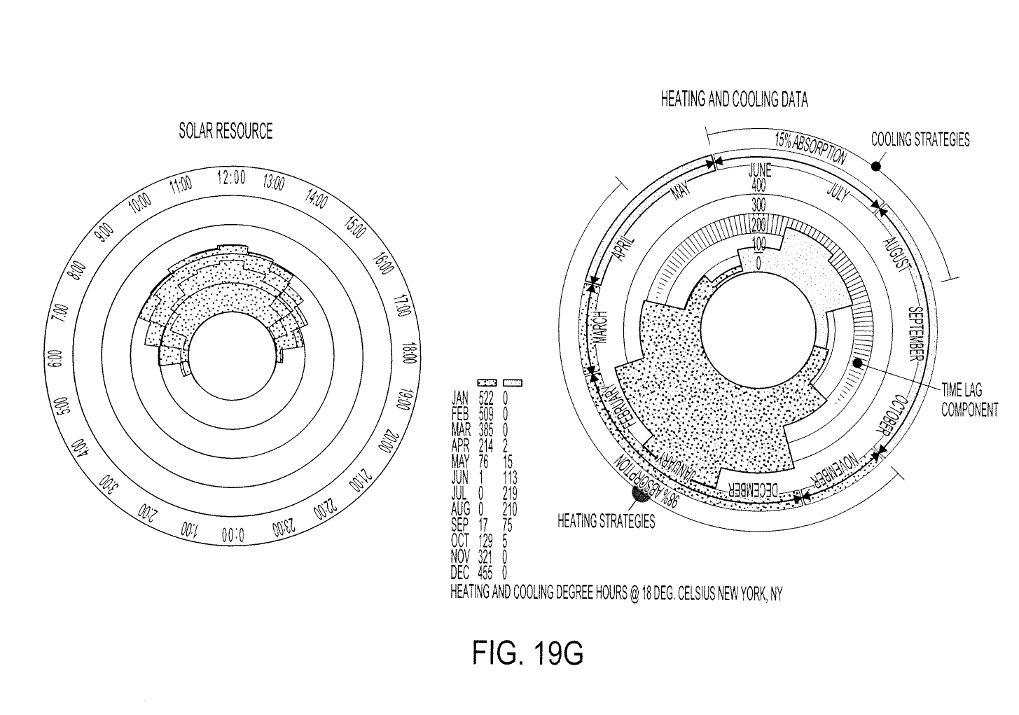

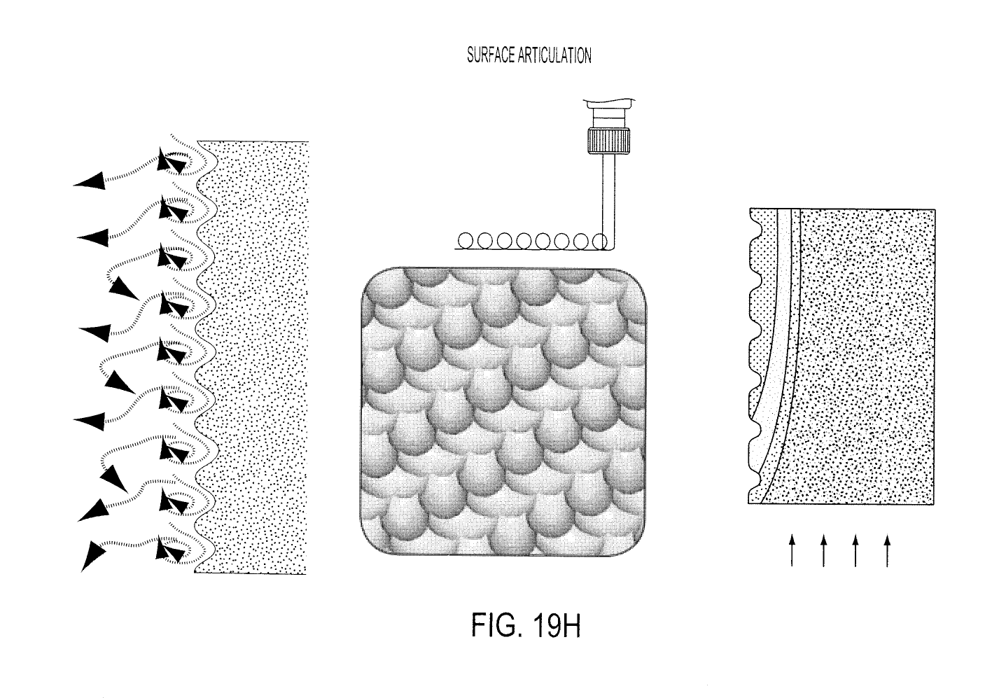

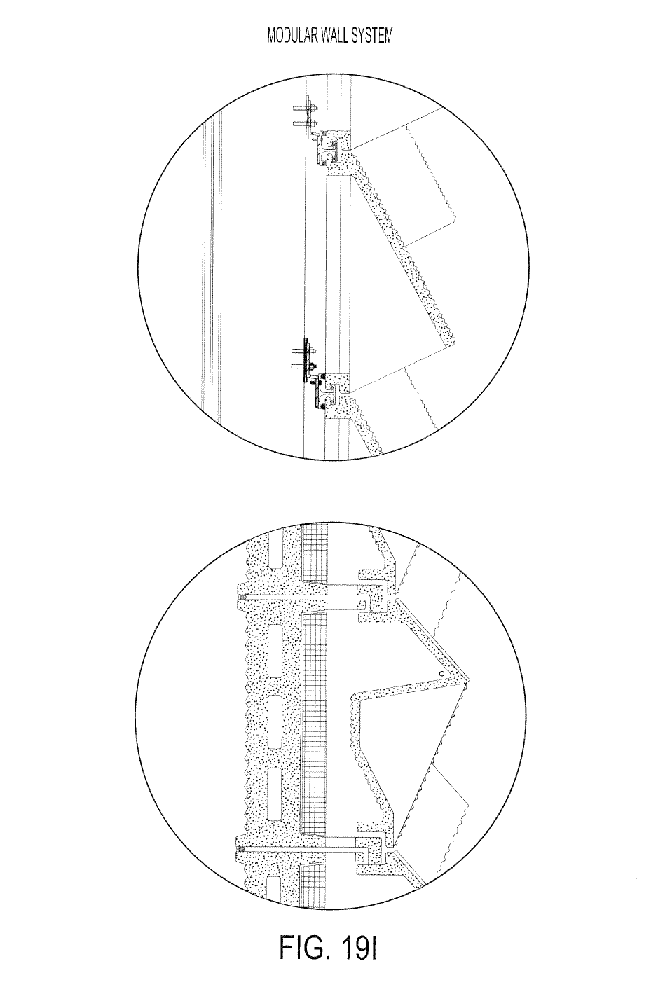

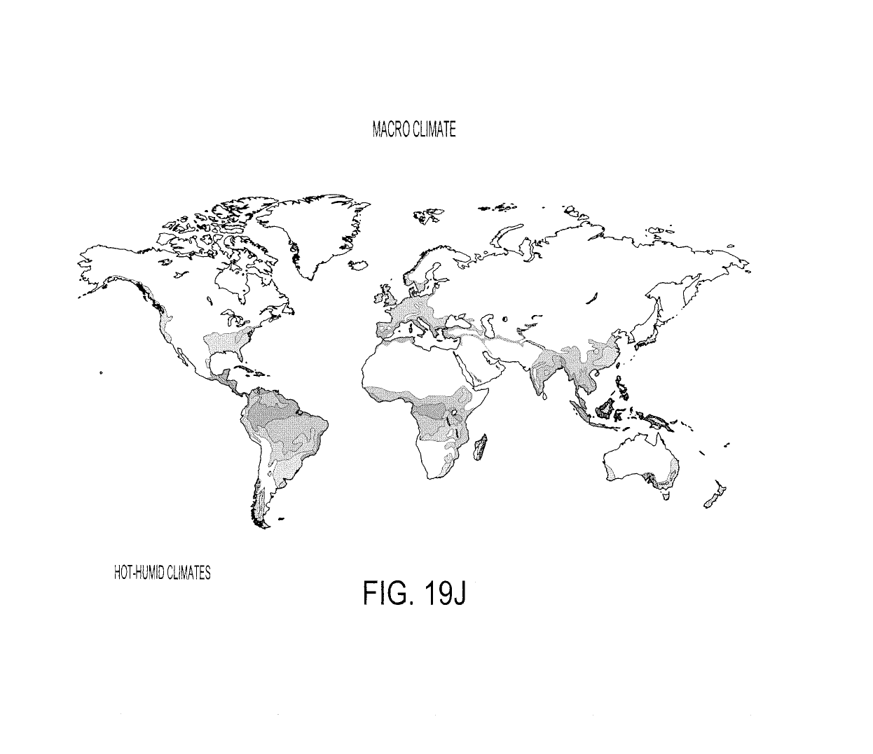

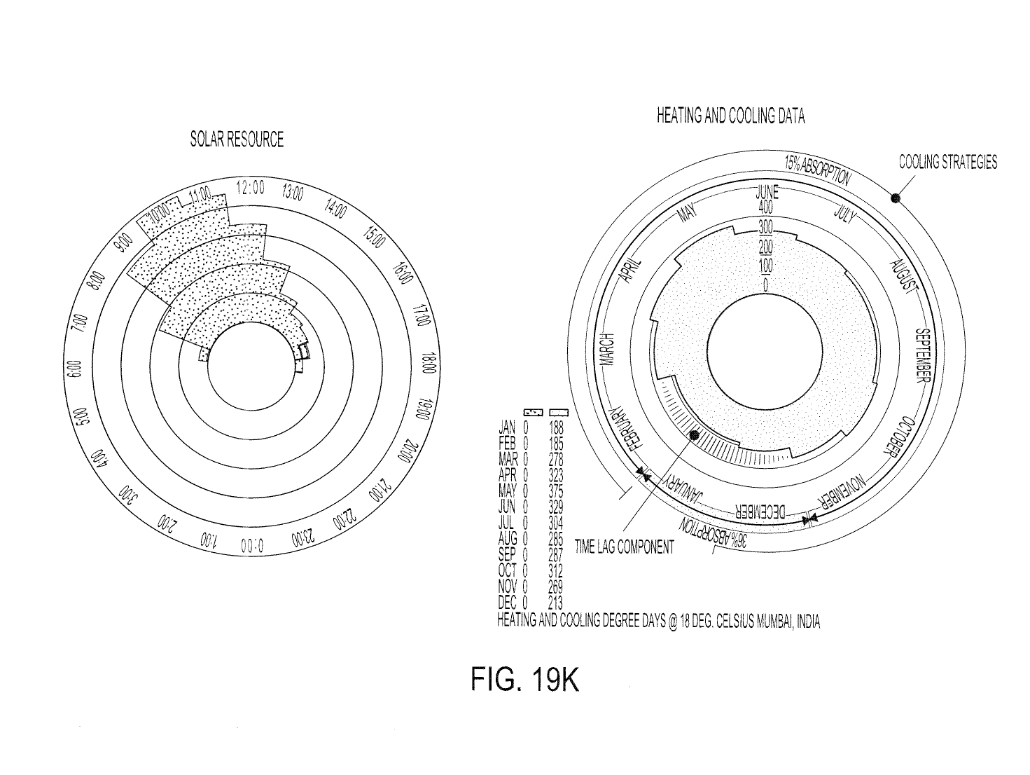

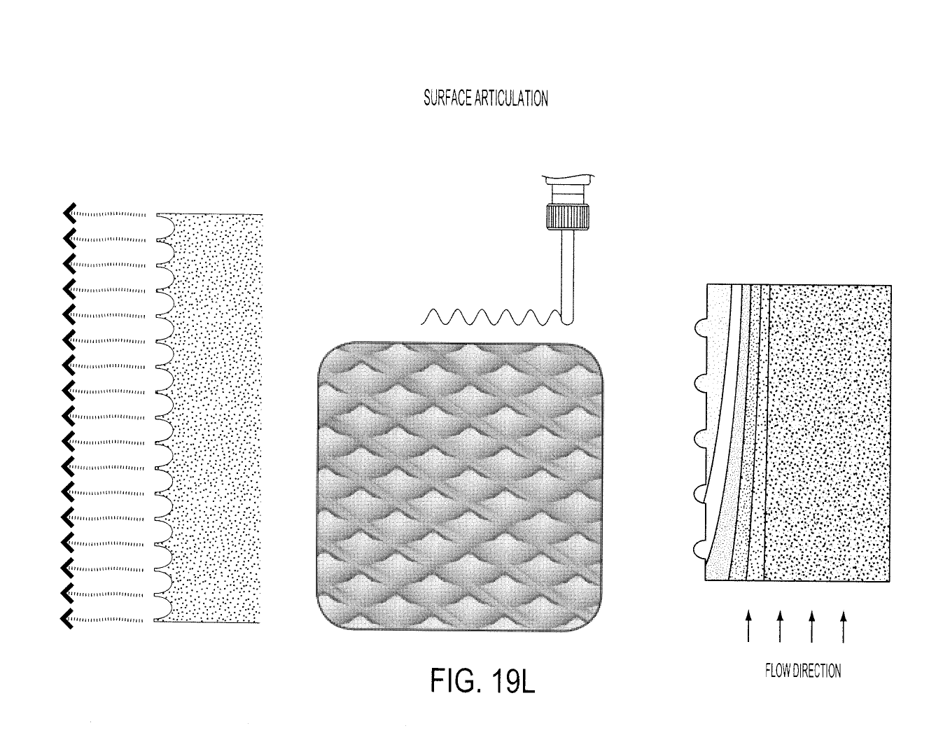

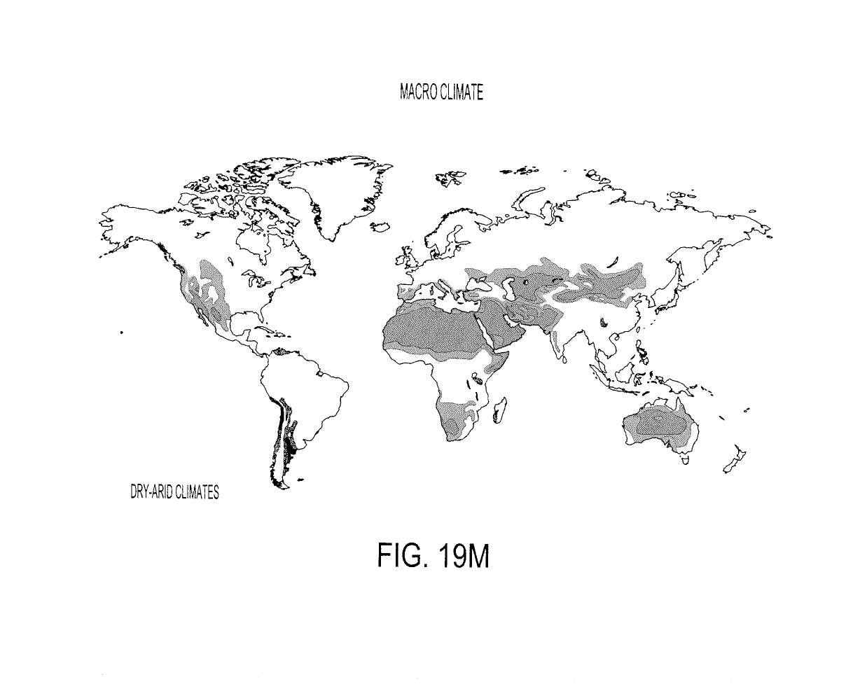

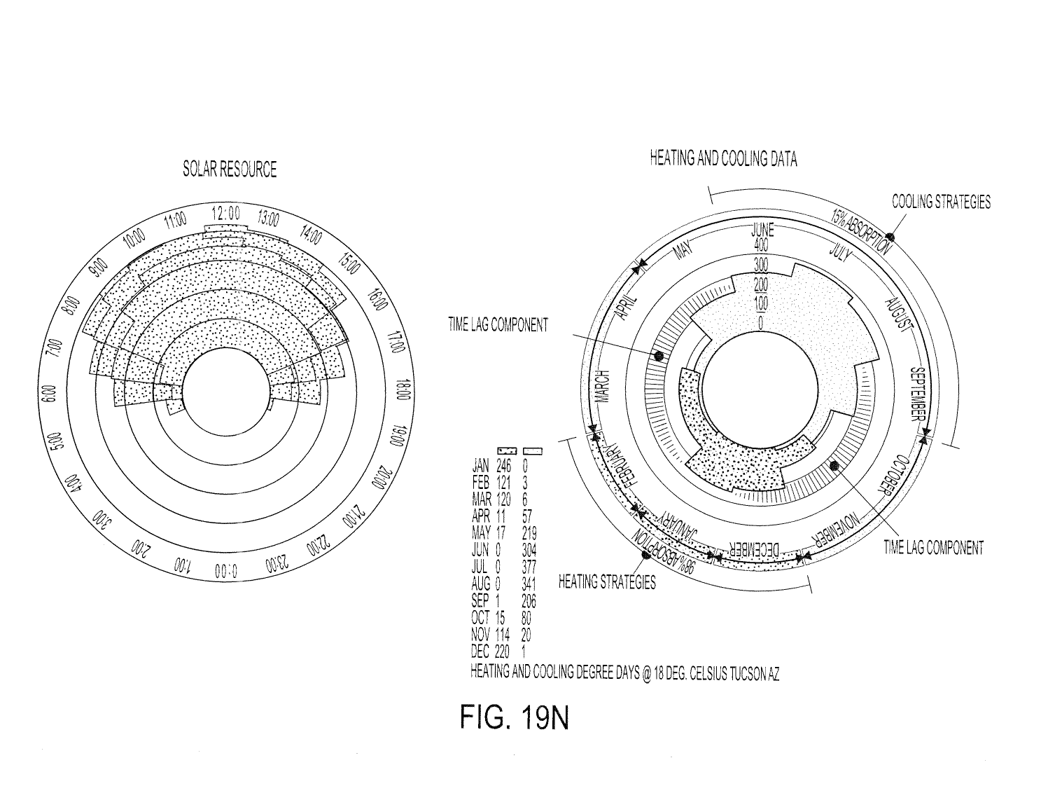

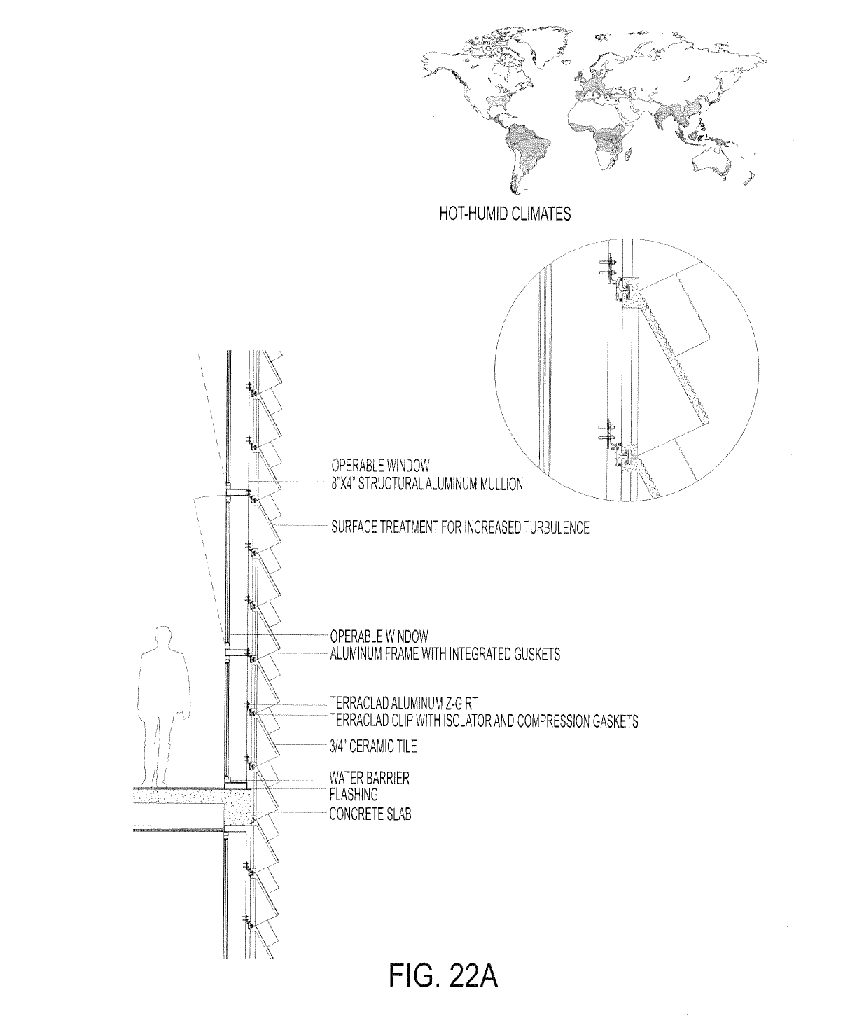

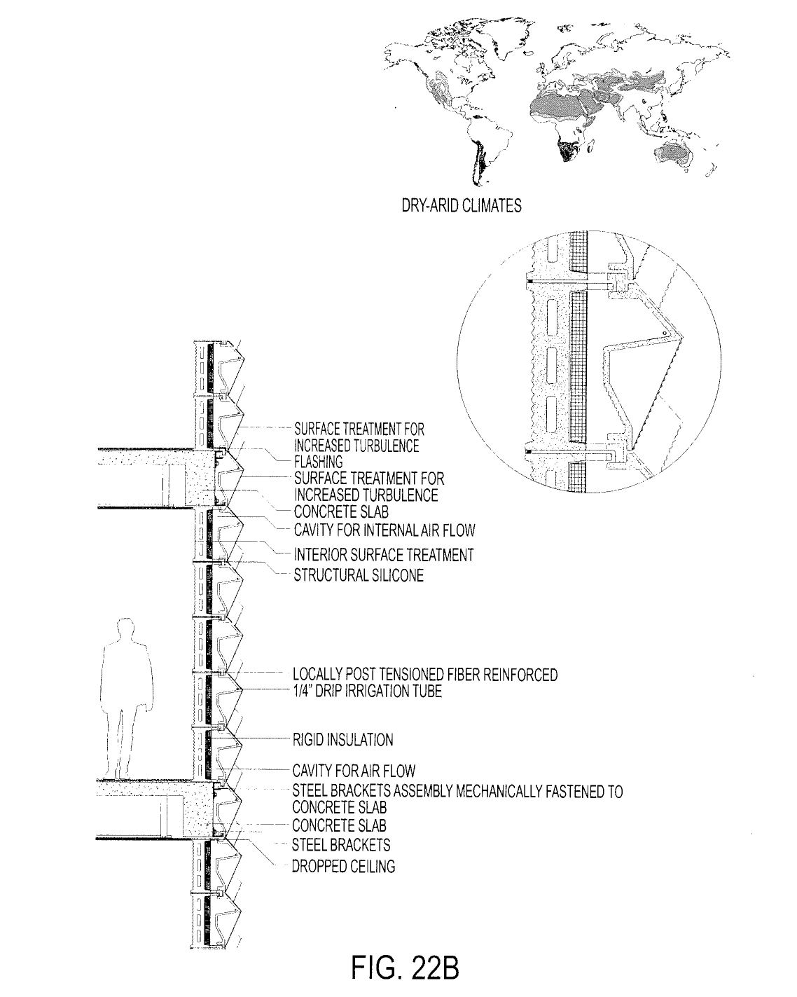

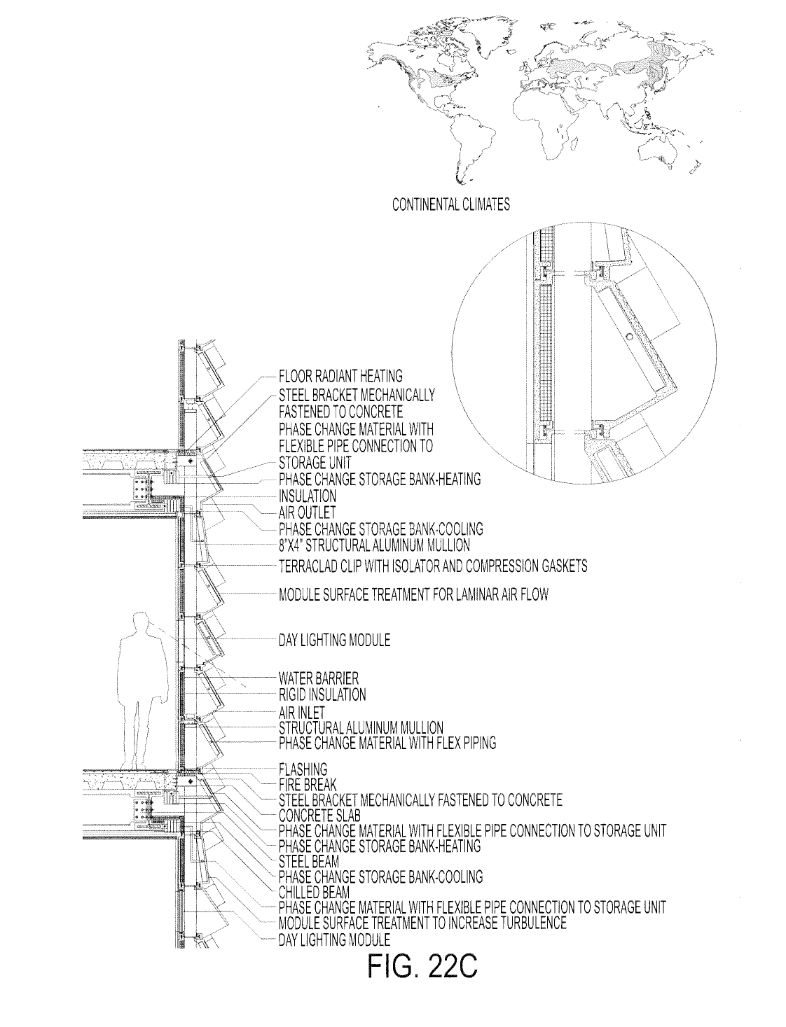

FIG. 18 provides an illustration of the determination of such a strategy. As shown in the figure, the façade envelope described in this embodiment uses a combination of a plurality of parameters (e.g., phase change material, coloration, etc.) at different times of the day and year to maximize its effect on energy transfer. For example, as shown in the figure, the system described in this embodiment can provide about 95% of solar absorption in the winter months but only 15% in the summer months. FIG. 19 further illustrates how the geometry and the different surface properties may be adjusted at different locales. FIGS. 22(A)-22(C) provide additional illustrations showing the different configurations adopted by the façade envelope in one embodiment at different locales.

The structure and methods described herein may affect the energy transfer and/or exchange via various mechanisms. For example, the affecting mechanism may involve absorbing, rejecting, or both, the flow of energy between the exterior and interior of the façade envelope. In some embodiments, when the temperature in the exterior of the envelope becomes too high, the façade envelope described herein may adjust at least one surface property to reject (or lower) the absorption of the solar energy into the building structure. In some other embodiments, when the temperature in the exterior of the envelope becomes low, such as lower than the interior of the structure, the façade envelope may adjust at least one surface property to retain the heat in the interior from being lost to the exterior of the building structure.

The mechanisms may involve, for example, alteration of the air flow pattern around the building façade envelope. In some embodiments, the façade envelope described herein thermo-regulates the building structure by creating different types of air flows—e.g., laminar, turbulent, or an air flow pattern in between. For example, the façade envelope may change at least one surface property to reduce air convection to impede energy exchange between the exterior and the interior of the envelope, thereby to provide insulation for the interior of the envelope. Alternatively, the façade envelope may change at least one surface property to increase air convection, thereby to promote energy exchange to remove excess energy from the interior of the envelope. In some embodiments, the façade may carry out a combination of these two mechanisms.

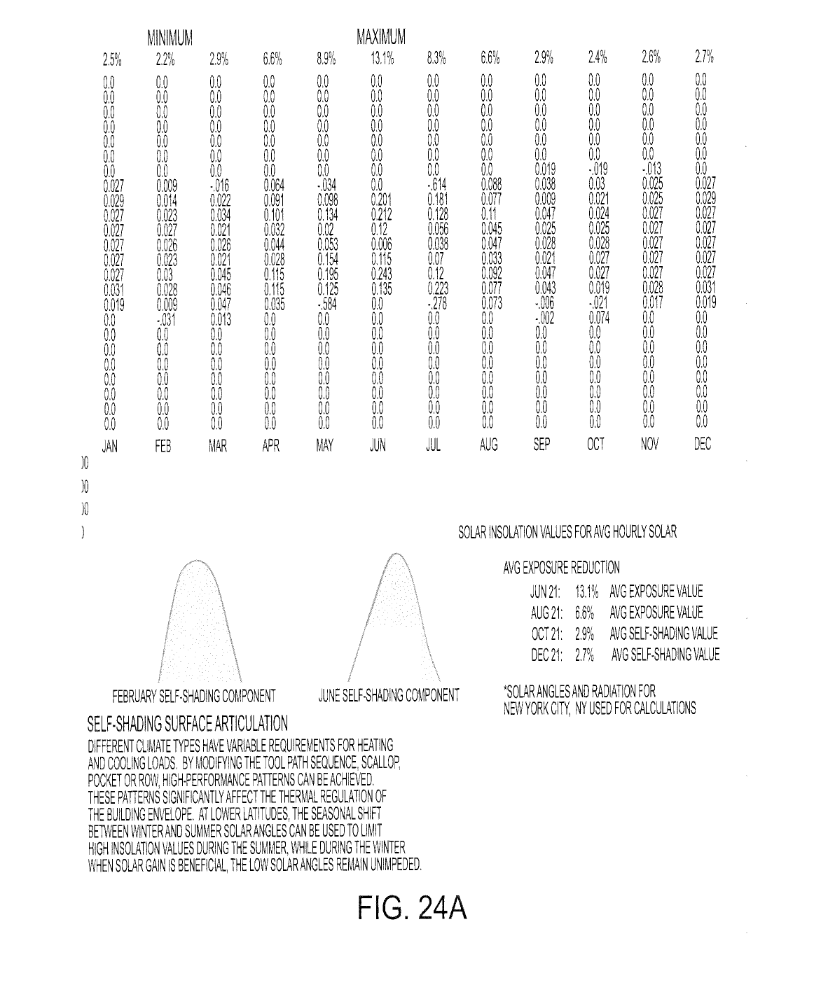

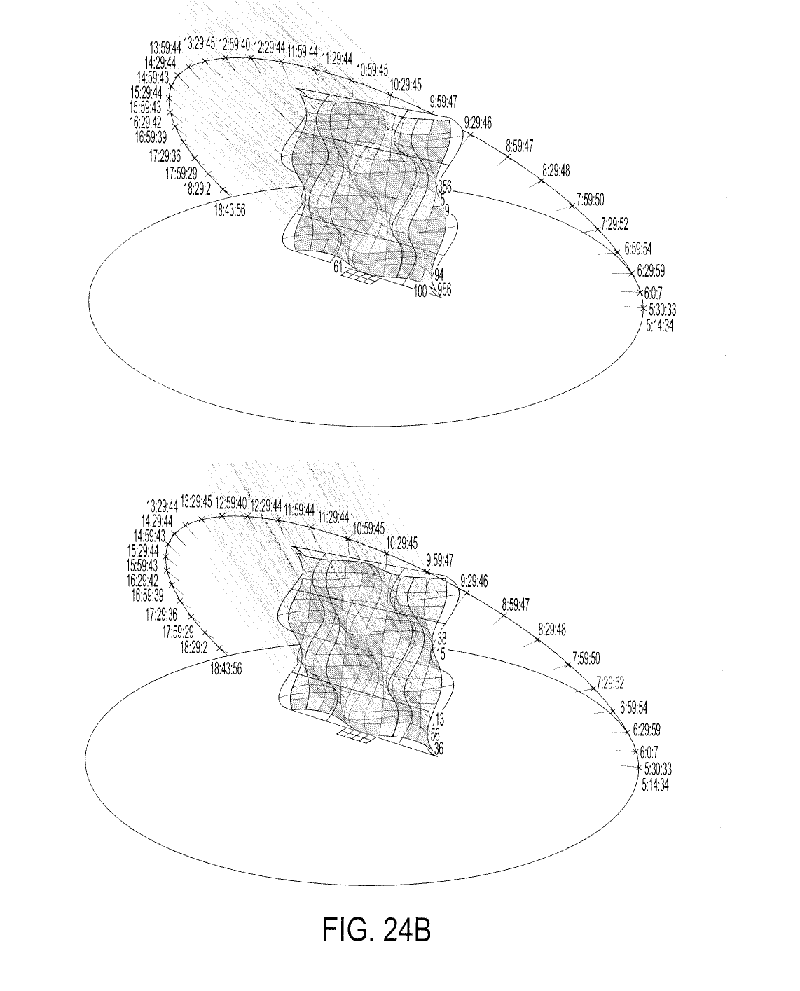

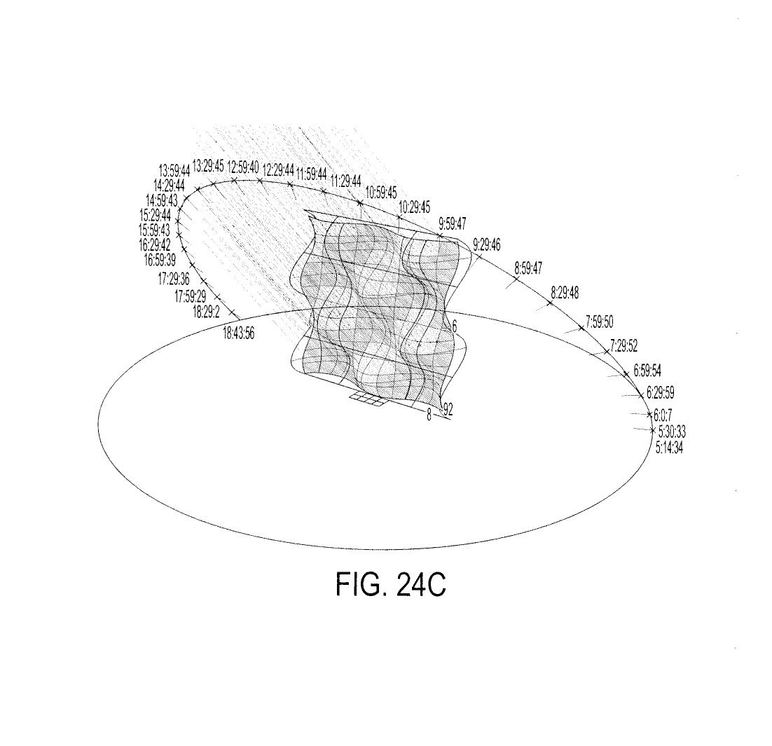

In some embodiments, the façade envelope described herein may thermo-regulate by adjusting the amount of self-shading (e.g., by changing the geometry and position of the tiles of the façade envelope). FIG. 24 provides such an example of self-shading surface articulation. As shown in FIG. 24, different climate types have variable needs for heating and cooling loads. By modifying the tool path sequence, scallop, pocket or row, high-performance patterns can be achieved. These patterns significantly affect the thermal regulation of the building envelope. At lower latitudes, the seasonal shift between winter and summer solar angles can be used to limit high insulation values during the summer, while during the winter when solar gain is beneficial, the low solar angles remain unimpeded.

Accordingly, one aspect of the inventive embodiments described herein is related to a method of regulating a temperature inside a building structure, such as a façade envelope of a building structure. The method may be carried out by adjusting at least one surface property of the structure to a climate to affect energy exchange between the exterior and the interior of the envelope. The method of adjusting may involve, for example, exposing different portions of the structure to the climate to affect energy exchange. Alternatively, it may involve rejecting energy from the interior to the exterior of the building façade envelope to decrease the temperature. In another embodiment, the method of adjusting may involve absorbing energy from the exterior to the interior of the building façade envelope to increase the temperature.

The methods described herein may be carried out dynamically to adjust actively and proactively the envelope to adapt to the change of the environment. Thus, in some embodiments, the changing of the building façade envelope property to adjust to the change of climate may be automated. For example, the façade envelope may be programmed to change any of the aforedescribed surface properties at the different times of the day. Accordingly, by actively and proactively adjusting the structure (e.g., surface property thereof) to the different climate conditions, the façade envelope described herein may increase or decrease the absorption or reflection of the exterior heat, thereby to be used to decrease peak thermal gain, midday and summer building loads, or increase thermal gain as an advantage in cold weather.

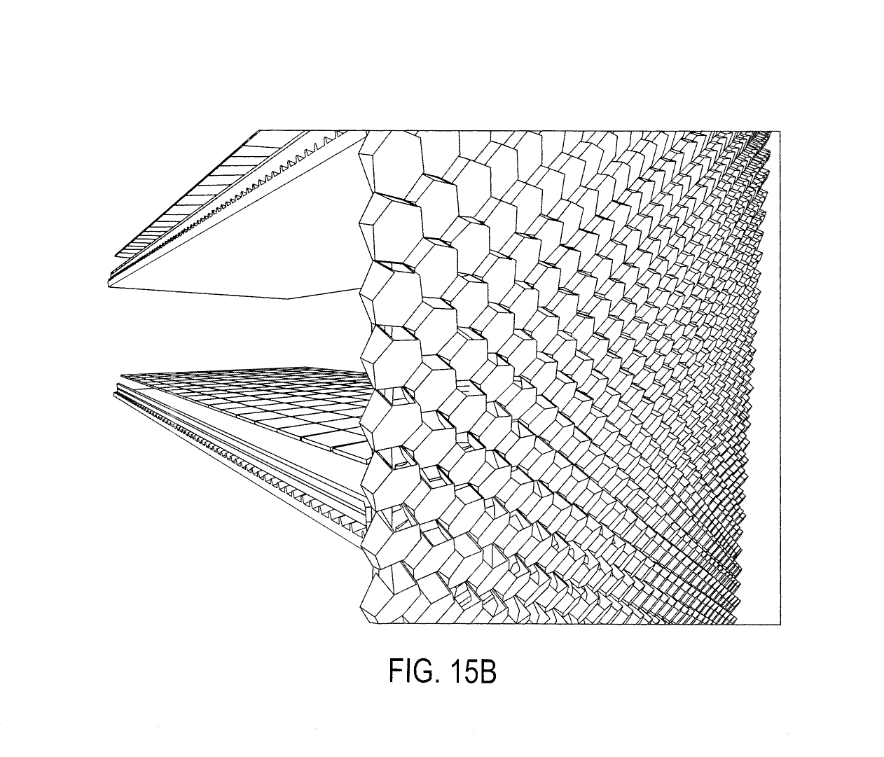

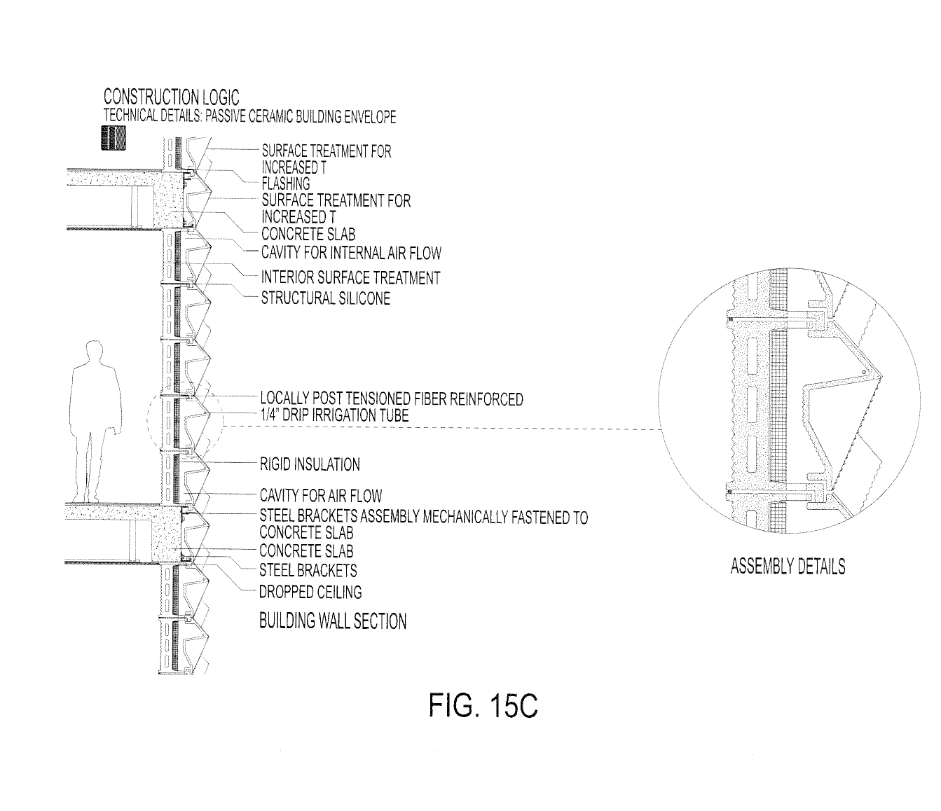

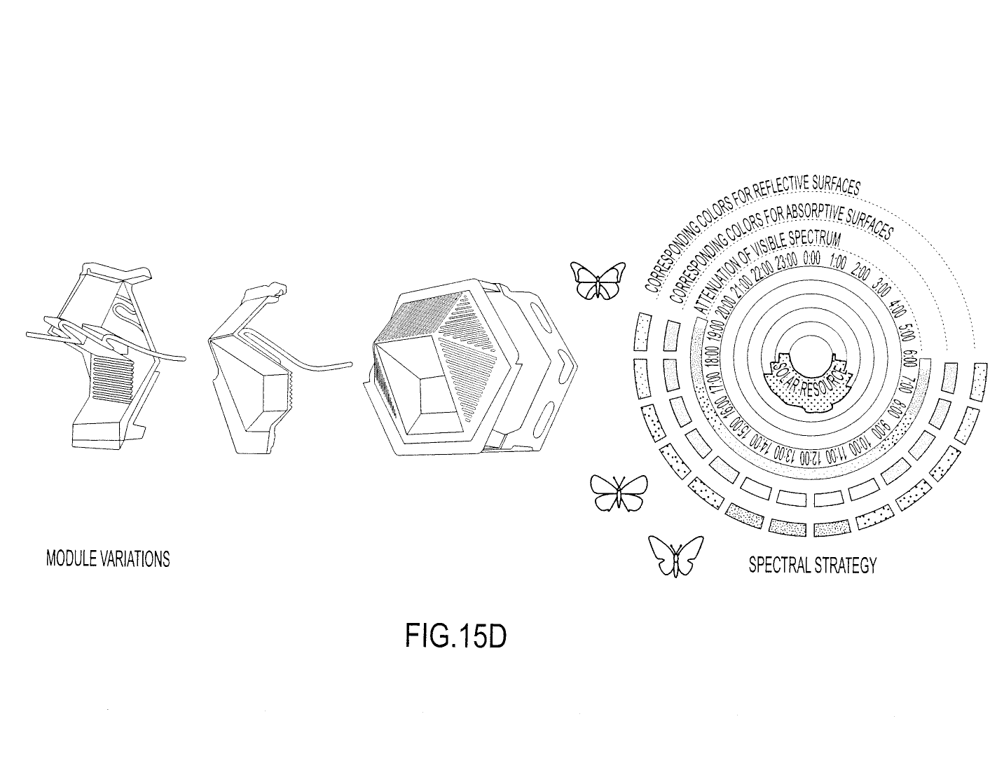

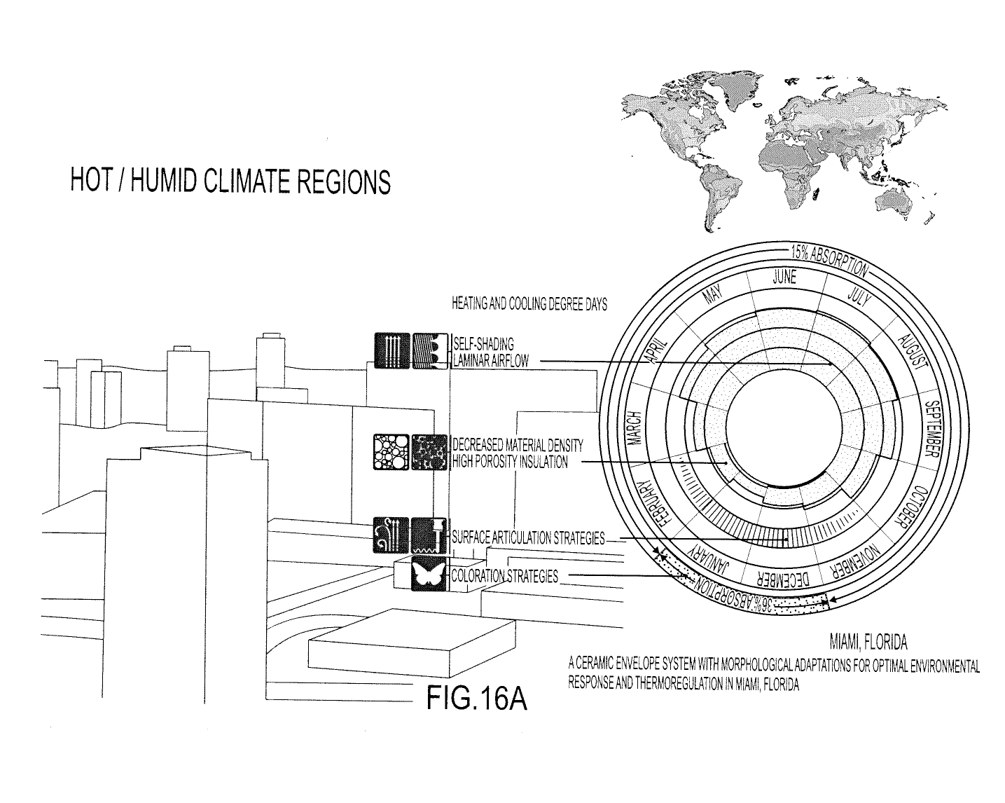

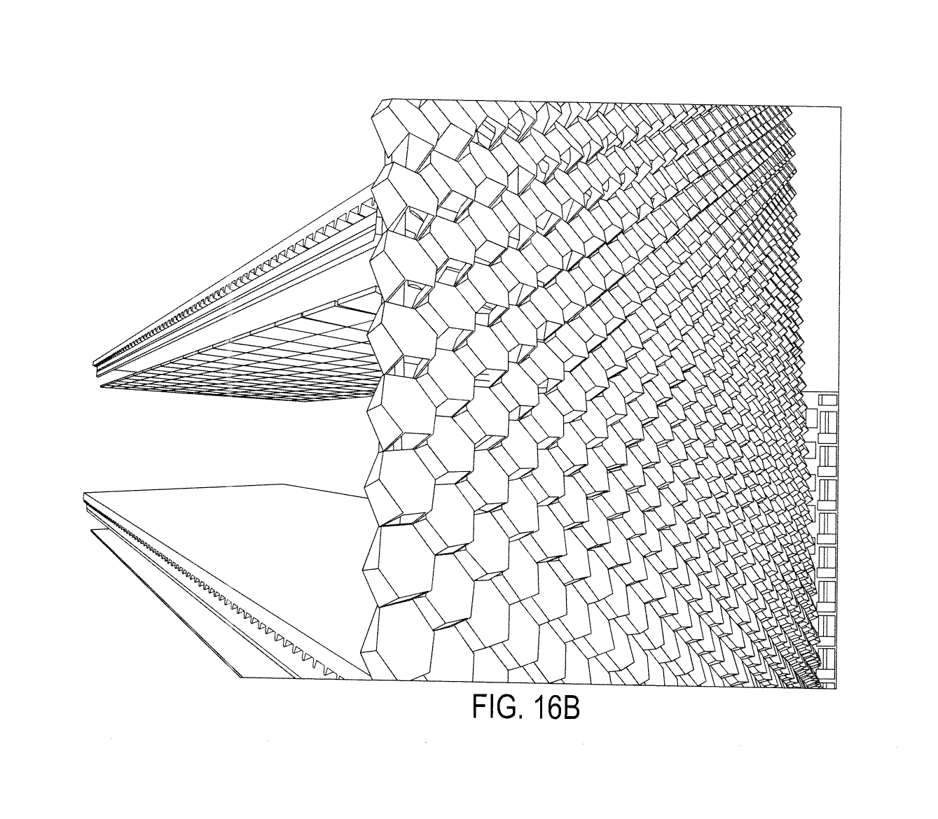

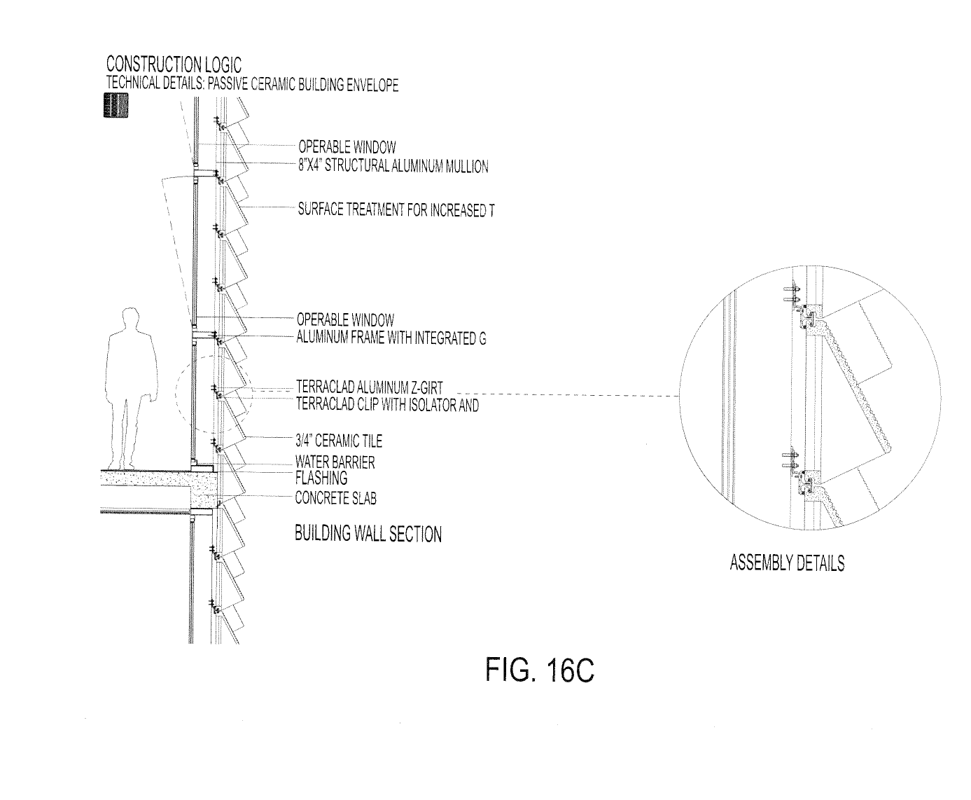

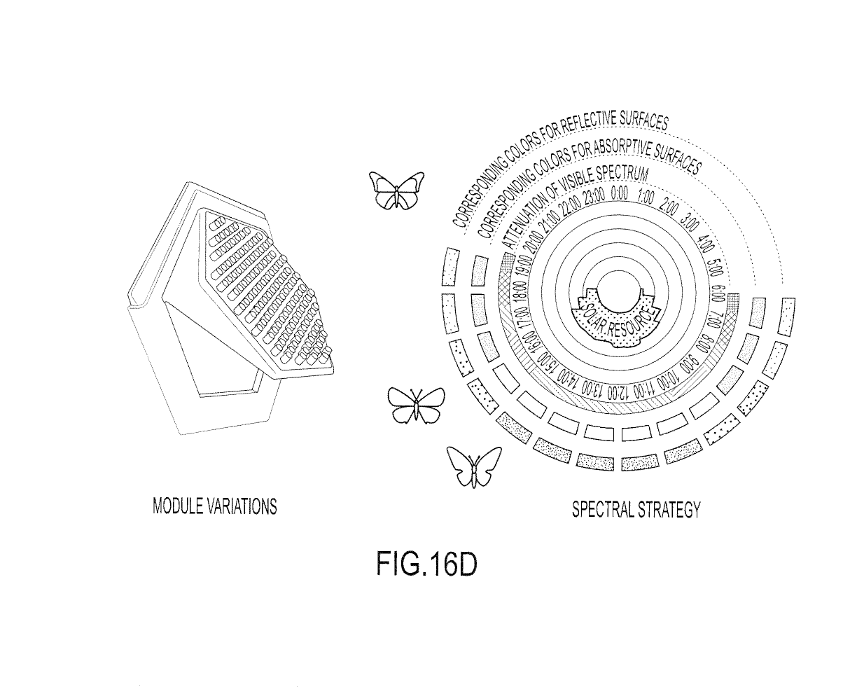

Further, the programming of the adjustment may further take into account the locale of the structure that will be deployed. One example is that a structure located in New York City would adjust its surface property differently from another structure located in Phoenix, Ariz. because of the differences in the climate. FIGS. 15(A)-15(D) and 16(A)-16(D) further illustrate the differences (with respect to the various design parameters) between a façade envelope construction used for, respectively, a hot and arid environment and a hot and humid environment. Thus, the desirable routine of the adjusting, including when to adjust the surface property to which type, may be predetermined and programmed to be executed after the façade envelope is installed and deployed on site.

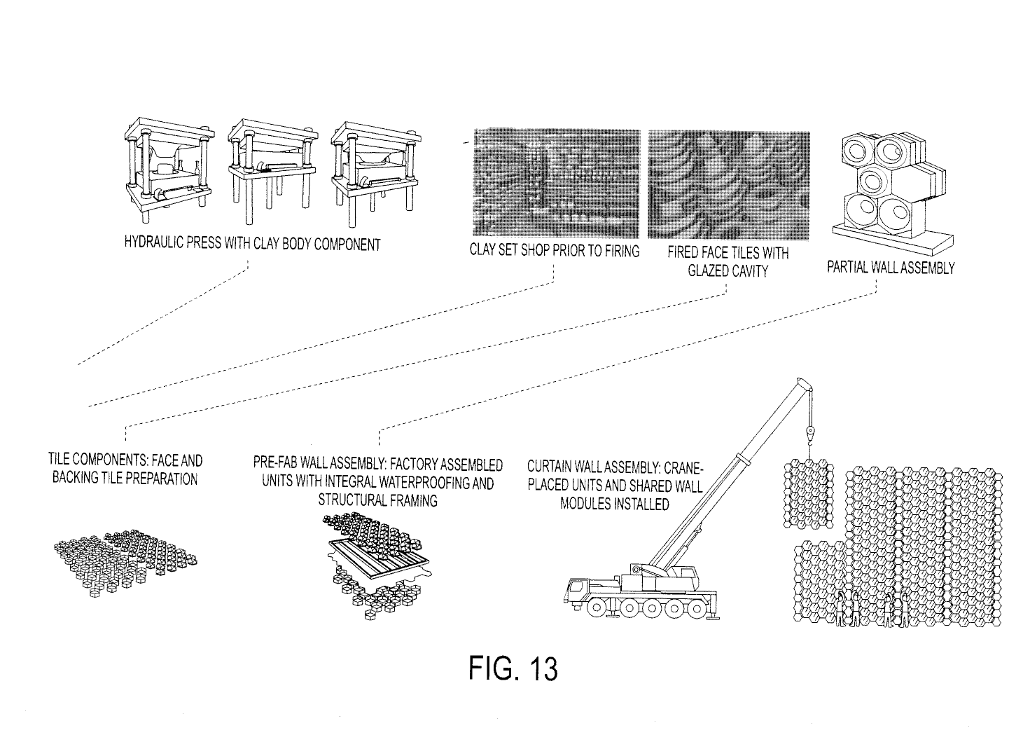

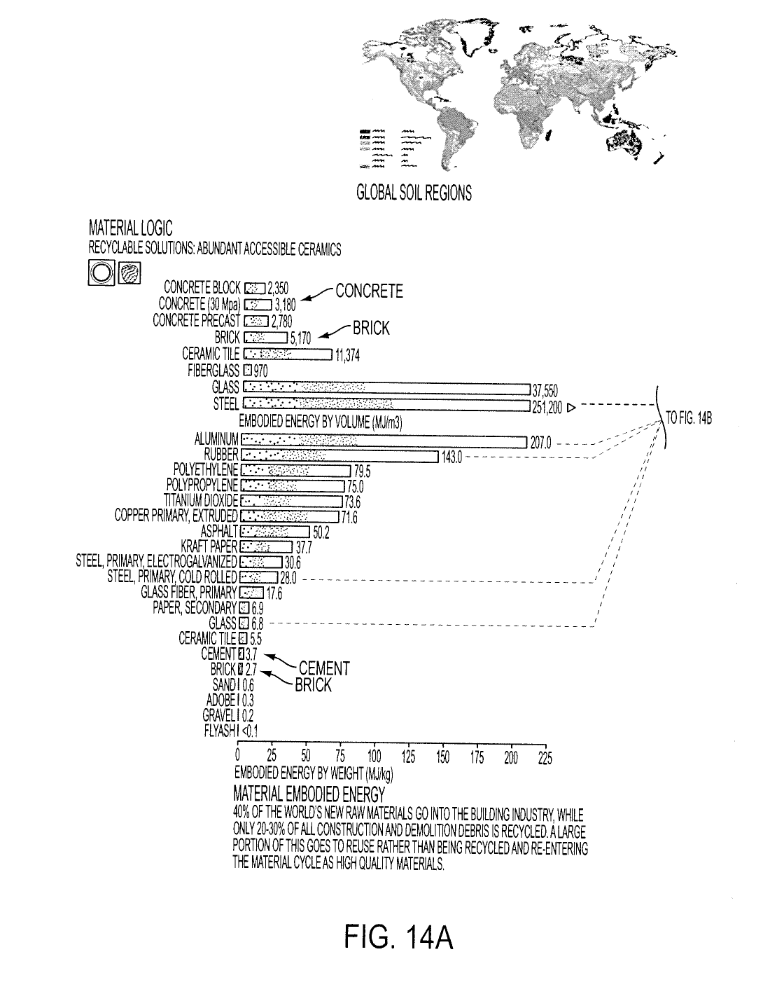

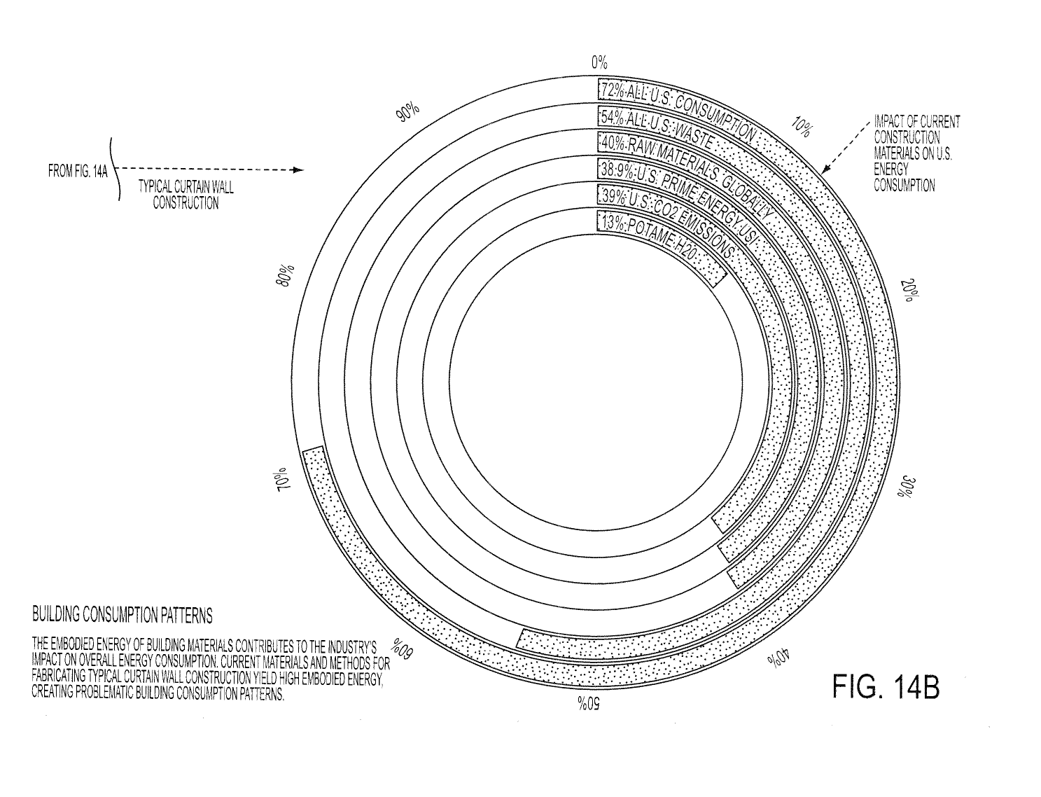

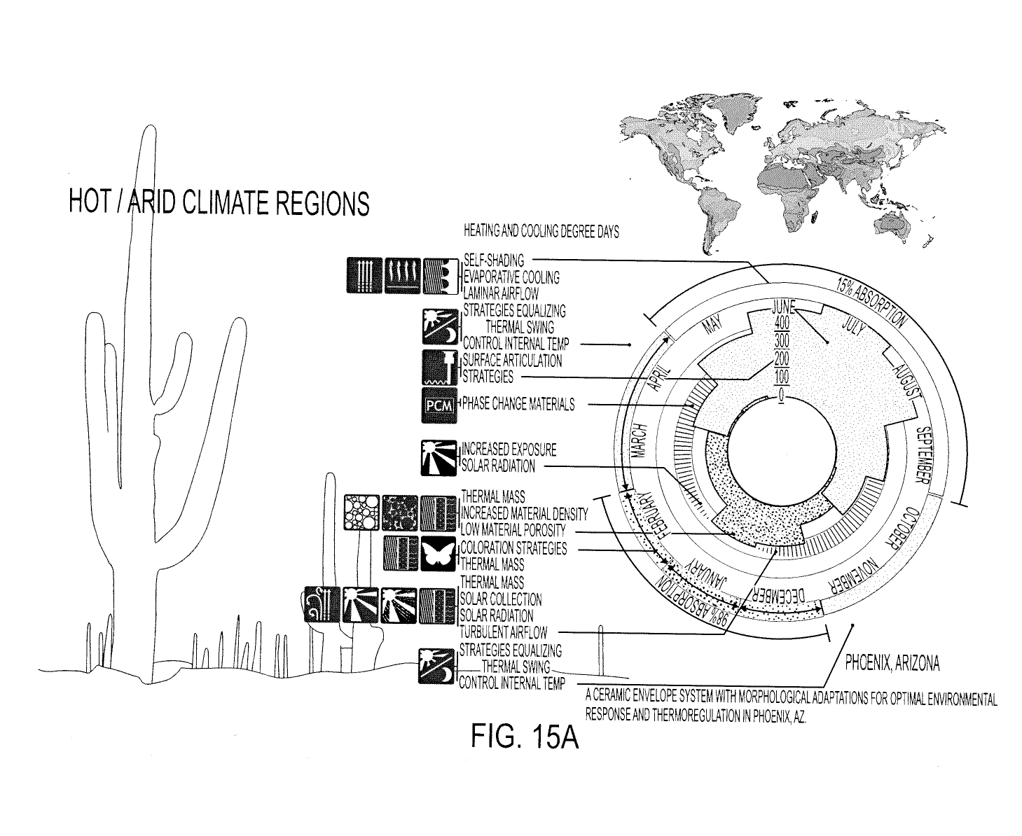

The façade envelope may be fabricated by any convention techniques. For example, the façade envelope may be fabricated by computer numeric control (CNC). Other types of milled molds may be employed as well. In some embodiments, geometry designed for specific climate and/or on site conditions can be fabricated on demand with CNC technology. Depending on the demand and need, integrated (in-place) insulation may be connected to an interior re-radiating surface of the curtain wall (e.g., including reflective glazing on the insulation side) of the façade envelope. FIGS. 12-14 illustrate the parameters considered during the manufacturing of the structure in one embodiment

In some embodiments, the excess heat or solar energy collected by the façade envelope may be used to generate an additional form of energy—e.g., electricity. For example, in one embodiment wherein the façade envelope comprises solar cell, the collected solar energy may be used to generate electricity. As described above, the electricity (or other forms of energy) may be generated on the façade envelope or on a separate device attached to or connected to the façade envelope. The energy may be generated via different mechanisms, depending on the materials used. For example, electricity may be generated via reverse Peltier effect, Seebeck effect, Stirling engine, or combinations thereof, via a stand-alone generator or integrated panel. Alternatively, electricity may be generated via organic Rankine cycle via an integrated component connected to the façade envelope. In some embodiments, the collected energy may be employed to provide a cooling effect in the interior of the façade envelope. For example, the cooling may be accomplished by Seebeck effect via a stand alone generator or integrated panel. Alternatively, the energy may be used as an energy source of an integrated Chilled Beam or Heat Pump to remove excessive interior thermal loading.

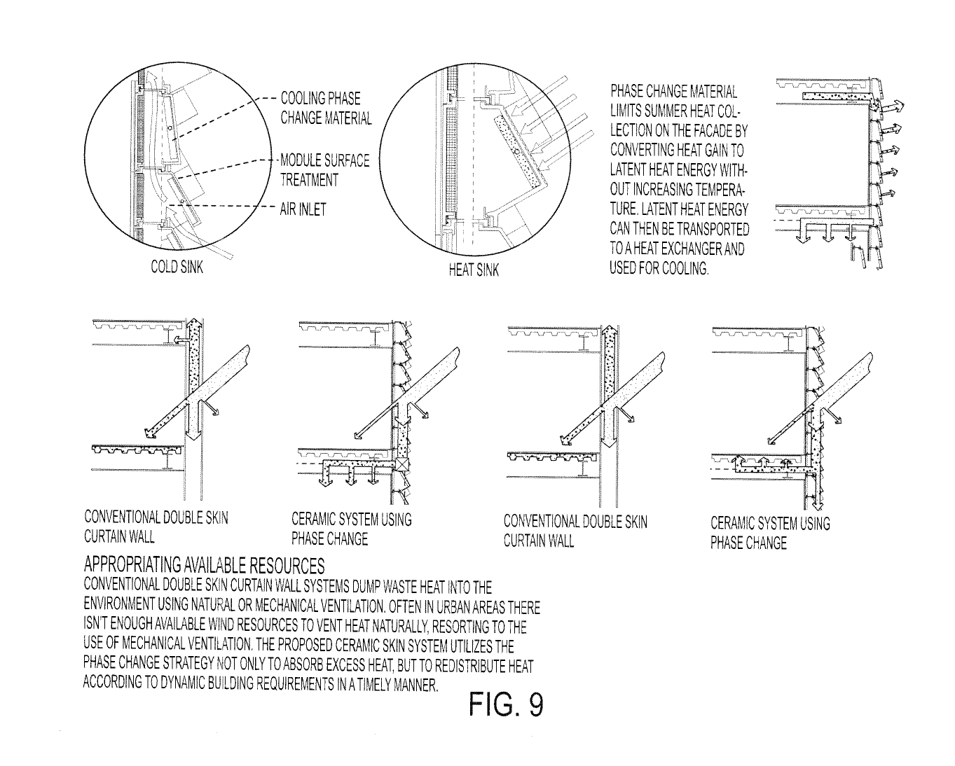

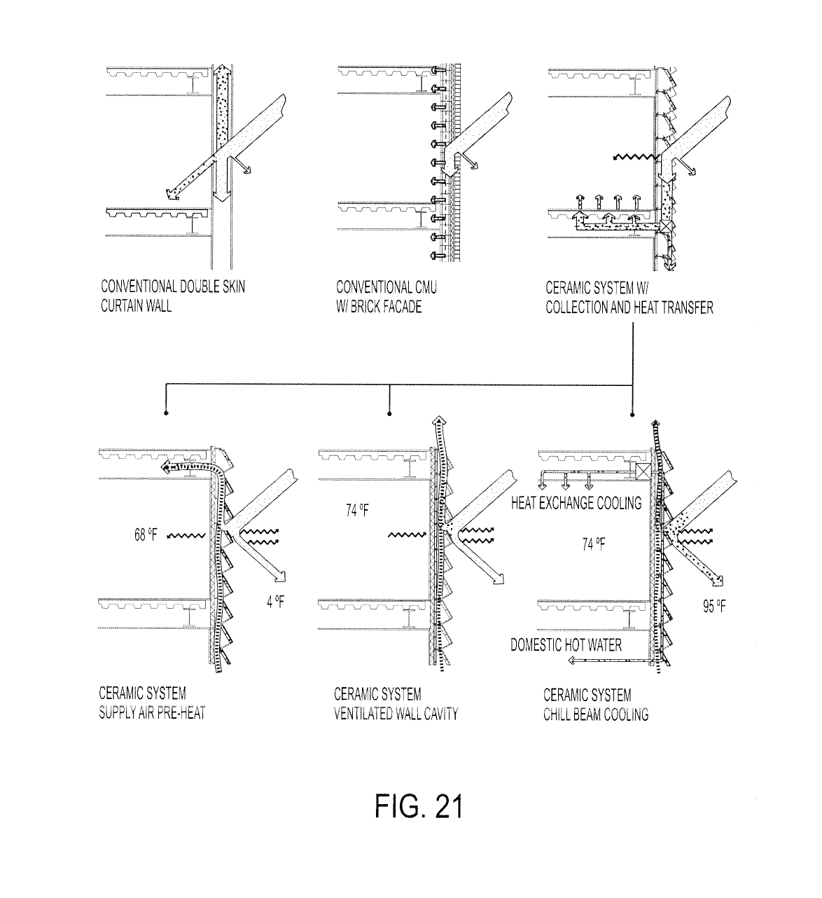

The structures and methods described herein allow a building façade envelope to be a non-passive participant (as in a conventional façade ) to adapt the building towards changing localized environmental conditions. Exemplary contrast between a conventional façade structure and the façade envelope described herein is provided in FIG. 9 and FIG. 21. As shown in FIG. 9 and FIG. 21, while the conventional façade system attempts to insulate the interior of the building from the exterior in a hot day, the heat is still retained in the wall of the façade , which indirectly results in an increase in the interior temperature. By contrast, the presently described façade system actively rejects the heat and minimizes retention of the heat in the wall of the façade .

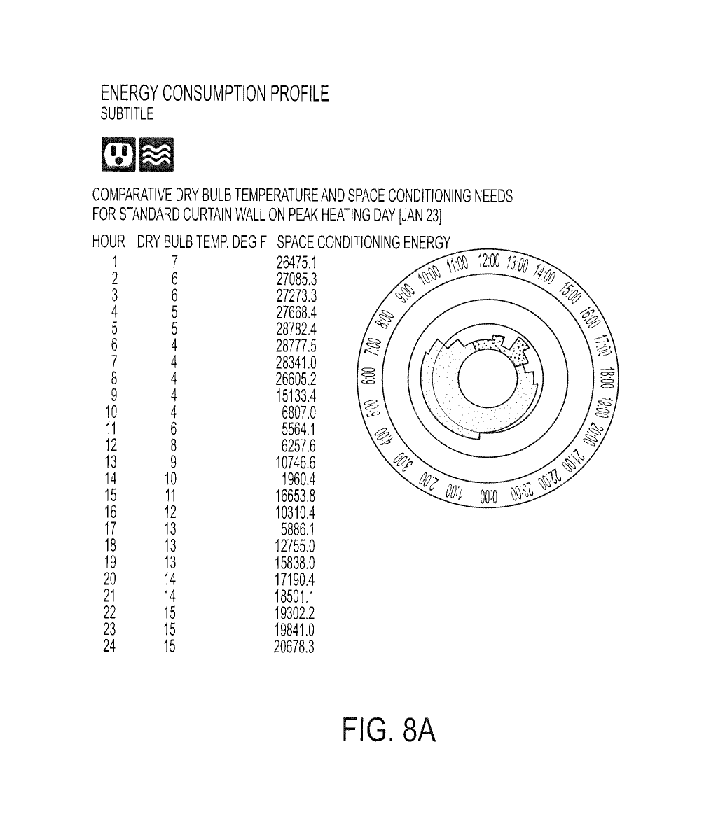

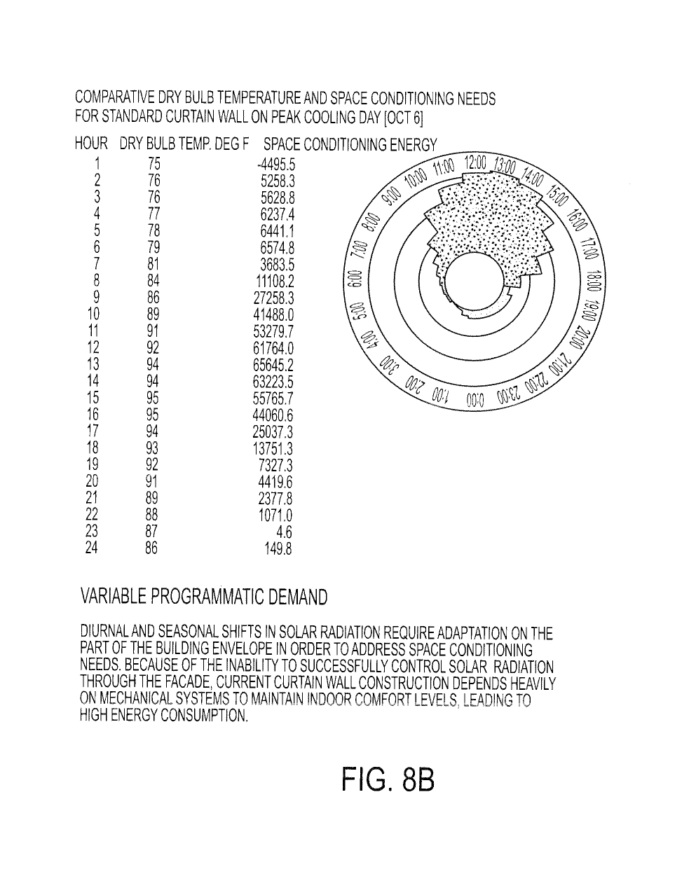

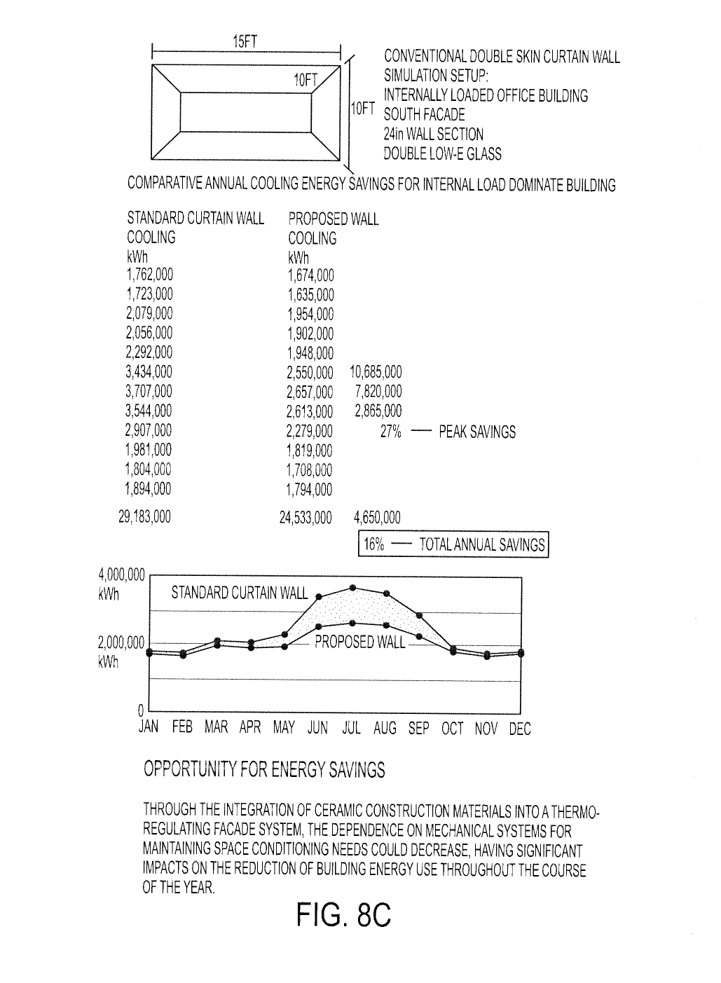

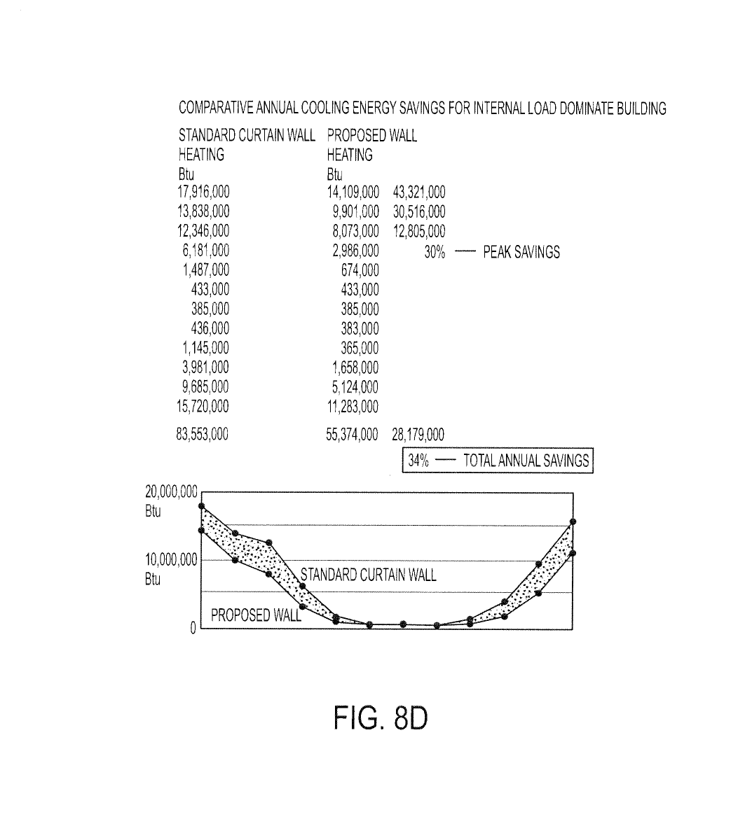

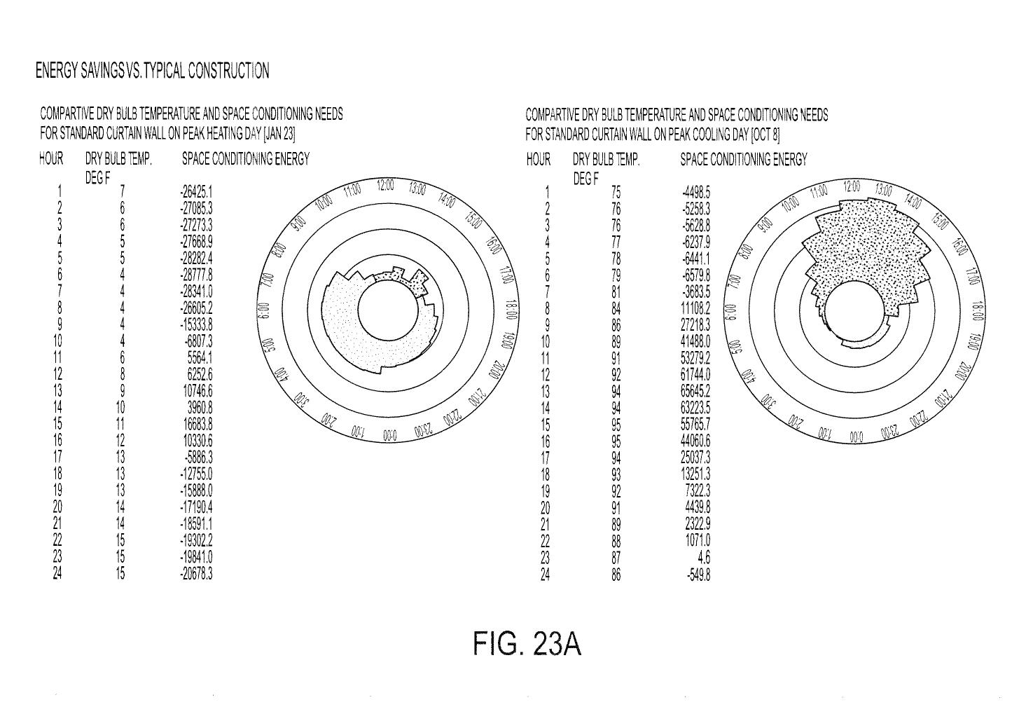

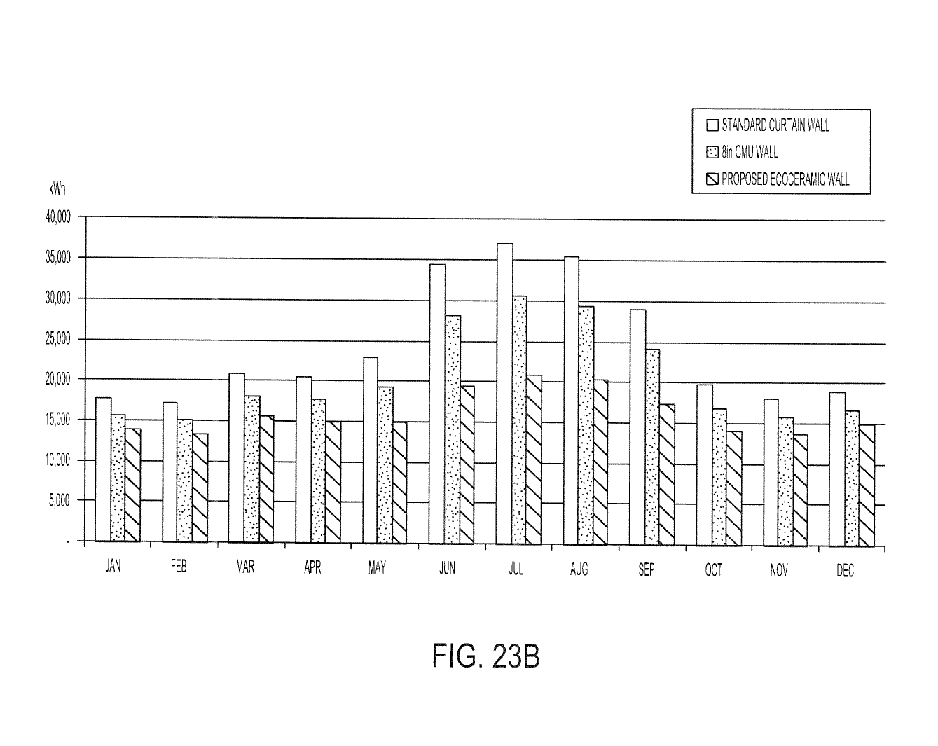

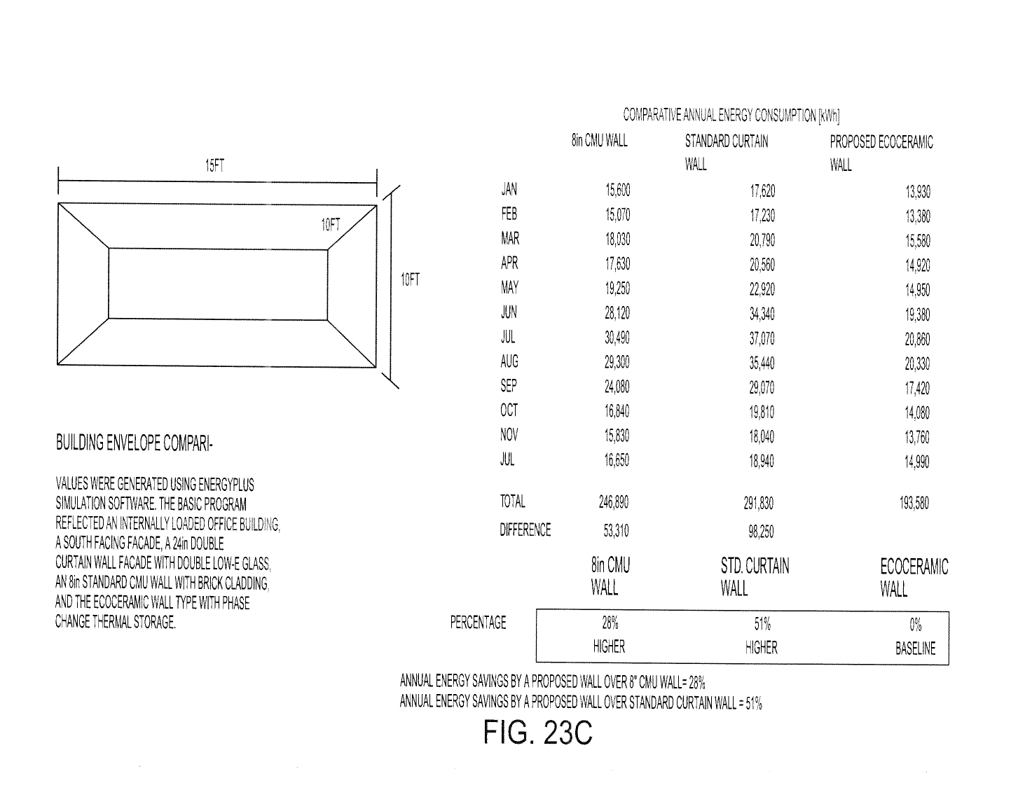

The façade envelope described may balance the energy profile of the building as a whole over time. In other words, based on bio-analytics, the façade envelopes described herein allow energy flows through the building enclosure to be harnessed to off load excess thermal loads, and passively cool internal load dominated buildings. FIG. 8 and FIG. 23 provide exemplary data showing the amount of savings one embodiment of the presently described façade system (“Proposed EcoCeramic Wall”) may achieve. As shown in the figure, a conventional CMU wall is about 28% and a conventional standard curtain wall is about 51% higher than the presently described system with respect to energy consumption.

The temperature differentials between the interior and the exterior can also be harvested by the system to create cooling, heating or electricity through a variety of means including organic Rankine cycle and reverse Seebeck effect. The façade envelope assembly described herein may integrate a geometrically complex, modular wall system with components that can be easily modified, replaced, reclaimed and ultimately recycled for new façade components not only to improve façade performance, but to provide new possibilities for designers, clients and user.

The articles “a” and “an” are used herein to refer to one or to more than one (i.e., to at least one) of the grammatical object of the article. By way of example, “a polymer resin” means one polymer resin or more than one polymer resin. Any ranges cited herein are inclusive. The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

What is claimed:

1. An article, comprising:
a material, which adjusts at least one surface property in response to a climate condition, to affect energy exchange between the exterior and the interior of the article.

2. The article of claim 1, wherein the material comprises a ceramic.

3. The article of claim 1, wherein the material comprises a ceramic comprising clay.

4. The article of claim 1, wherein the material comprises a metal.

5. The article of claim 1, wherein the material comprises a metal comprising aluminum.

6. The article of claim 1, wherein the material comprises a phase change material.

7. The article of claim 1, wherein the material further comprises a solar cell.

8. The article of claim 1, wherein the surface property is at least one of geometry, coloration, and surface morphology.

9. The article of claim 1, wherein the energy is at least one of heat, light, and radiation.

10. The article of claim 1, wherein the article is a part of a building envelope.

11. A structure, comprising:
a building façade envelope, comprising a material:
wherein the envelope adjusts at least one surface property in response to a climate condition to affect energy exchange between the exterior and the interior of the envelope.

12. The structure of claim 11, wherein the climate is specific to a geographical location of the structure.

13. The structure of claim 11, wherein the surface property is at least one of geometry, coloration, and surface morphology.

14. The structure of claim 11, wherein the material comprises ceramic, a metal, or a combination thereof.

15. The structure of claim 11, wherein the material comprises a pressure cast modular ceramic.

16. The structure of claim 11, wherein the envelope comprises a clipping system attaching the material to the envelope.

17. The structure of claim 11, wherein the material comprises oversized ceramic tiles.

18. The structure of claim 11, wherein the material comprises a photovoltaic material, a thermoelectric material, or both.

19. The structure of claim 11, wherein the structure further comprises an energy generation system connected to the building envelope.

20. The structure of claim 11, wherein the structure further comprises a heating device, a cooling device, or both, connected to the building envelope.

21. The structure of claim 11, wherein the material further comprises a thermochromatic coating.

22. The structure of claim 11, wherein the surface property is at least one of geometry, coloration, and surface morphology.

23. The structure of claim 11, wherein the surface property comprises emissivity of the material.

24. The structure of claim 11, wherein the surface property comprises surface texture of the material.

25. The structure of claim 11, wherein the climate involves temperature, level of solar radiation, level of pollutants, or combinations thereof.

26. The structure of claim 11, wherein the affecting of energy exchange involves absorbing, rejecting, or both, the energy between the exterior and the interior of the building envelope.

27. The structure of claim 11, wherein the affecting of energy exchange involves modifying airflow around the building façade envelope.

28. The structure of claim 11, wherein the affecting of energy exchange involves at least one of (i) reducing air convection to impede energy exchange to provide insulation for the interior of the envelope and (ii) increasing air convection to promote energy exchange to remove excess energy from the interior of the envelope.

29. The structure of claim 11, wherein the material is in a form of a plurality of tiles.

30. The structure of claim 11, wherein the building façade comprises a phase change material.

31. A structure, comprising:
a building façade envelope, comprising a plurality of a plurality of ceramic tiles and a storage container;
wherein the envelope adjusts at least one surface property in response to a climate to affect energy exchange between the exterior and the interior of the envelope.

32. The structure of claim 31, wherein the storage container comprises a phase change material.

33. The structure of claim 31, wherein the storage container is located within the tiles, a panel, an internal air cavity, or combinations thereof, of the envelope.

34. The structure of claim 31, wherein the storage container produces, removes, or both, heat for at least one of a building system and a thermoelectric generator, which is a part of the structure.

35. The structure of claim 31, wherein the ceramic tiles comprise a first ceramic material and a second ceramic material and the first ceramic material has a higher emissivity than the second ceramic material.

36. A method of regulating a temperature inside a structure, the method comprising:
adjusting at least one surface property of the structure to a climate condition to affect energy exchange between the exterior and the interior of the envelope;
wherein the structure comprises a building façade envelope.

37. The method of claim 36, wherein the method is automated.

38. The method of claim 36, wherein the adjusting further comprises changing at least one of the geometry, coloration, and surface morphology of the building façade envelope.

39. The method of claim 36, wherein the adjusting further comprises exposing different portions of the structure to the climate to affect energy exchange.

40. The method of claim 36, further comprising rejecting energy from the interior to the exterior of the building façade envelope to decrease the temperature.

41. The method of claim 36, further comprising absorbing energy from the exterior to the interior of the building façade envelope to increase the interior temperature.

42. The method of claim 36, further comprising generating a second energy from the energy exchange.

43. The method of claim 36, further comprising generating electricity from the energy exchange.

44. The method of claim 36, further comprising making the building façade envelope by computer numeric control.

45. The method of claim 36, wherein the adjusting further comprises adjusting the at least one surface to a predetermined level.
